(19) United States
(12) Patent Application Publication
(10) Pub. No.: US 2014/0055423 A1
(43) Pub. Date: Feb. 27, 2014

(54) IMAGE-DISPLAY-DEVICE DRIVE METHOD, IMAGE DISPLAY DEVICE, AND IMAGE DISPLAY SYSTEM

(71) Applicant: PANASONIC CORPORATION, Osaka (JP)

(72) Inventors: Takateru Sawada, Osaka (JP); Takahiko Origuchi, Osaka (JP); Takashi Manabe, Osaka (JP); Hidehiko Shoji, Osaka (JP); Mitsuhiro Ishizuka, Osaka (JP)

(73) Assignee: PANASONIC CORPORATION, Osaka (JP)

(21) Appl. No.: 14/114,887

(22) PCT Filed: Aug. 6, 2012
(86) PCT No.: PCT/JP2012/004967

§ 371 Date: Oct. 30, 2013

(30) Foreign Application Priority Data
Dec. 7, 2011 (JP) 2011-267958

(51) Int. Cl. G06F 3/042

(52) U.S. Cl. CPC G06F 3/042
USPC 345/175

(57) ABSTRACT

Discharge for detecting the position coordinates of an electronic pen is caused stably, and the position coordinates are detected accurately. For this purpose, in a driving method of an image display device, an image display subfield, a y-coordinate detection subfield, and an x-coordinate detection subfield are included in one field. In an initializing period of the x-coordinate detection subfield, a first voltage is applied to data electrodes and a first down-ramp voltage is applied to scan electrodes. In the initializing period of the image display subfield, a second voltage is applied to the data electrodes and a second down-ramp voltage is applied to the scan electrodes. The voltage derived by subtracting an arrival voltage of the first down-ramp voltage from the first voltage is set higher than the voltage derived by subtracting an arrival voltage of the second down-ramp voltage from the second voltage.

### TECHNICAL FIELD

The present invention relates to a driving method of an image display device for displaying an image in an image display region by combining binary controls of light emission and no light emission in a plurality of light emitting elements constituting a pixel, an image display device, and an image display system allowing a handwritten input of a character or drawing on the image display device using an electronic pen.

### BACKGROUND ART

A plasma display panel (hereinafter referred to as “panel”) is a typical example of an image display device for displaying an image in an image display region by combining binary controls of light emission and no light emission in each of a plurality of light emitting elements constituting a pixel.

The panel has many discharge cells as light emitting elements constituting pixels between a front substrate and a rear substrate that are faced to each other.

The front substrate includes a plurality of display electrode pairs disposed in parallel on a front glass substrate. Each display electrode pair is formed of a pair of scan electrode and sustain electrode. The rear substrate includes a plurality of data electrodes disposed in parallel on a rear glass substrate.

In each discharge cell, a phosphor of each of red (R), green (G), and blue (B) is applied and discharge gas is filled. In each discharge cell, ultraviolet rays are emitted by gas discharge, and the ultraviolet rays excite the phosphor to emit light.

A subfield method is generally used as a method of displaying an image in an image display region of the panel by combining binary controls of light emission and no light emission in a light emitting element.

In this subfield method, one field is divided into a plurality of subfields of different light emission luminances. In each discharge cell, light emission and no light emission of each subfield are controlled based on a combination corresponding to a gradation value to be displayed. Thus, light is emitted in each discharge cell at a brightness corresponding to the gradation value to be displayed, and an color image using a combination of various gradation values is displayed in the image display region of the panel.

Some of such image display devices have a function of allowing a handwritten input of a character or drawing on the panel using a pointing device called “electronic pen”.

In order to achieve the handwritten input function using an electronic pen, a technology of detecting the position of the electronic pen in the image display region is disclosed. Hereinafter, the coordinates indicating the position of the electronic pen in the image display region are referred to as “position coordinates”.

For example, in a plasma display apparatus disclosed in Patent Literature 1, an abscissa detection subfield for displaying a pattern for abscissa detection is set in one field. Light emission in the abscissa detection subfield is detected by an electronic pen, and the position (abscissa) of the electronic pen is detected based on the timing when the light emission is detected.

In the plasma display apparatus disclosed in Patent Literature 2, a position detection period for generating an optical signal for position coordinate detection is set in one field only when the position coordinates of the electronic pen are detected. The optical signal is detected by the electronic pen, and the position coordinates of the electronic pen are detected based on the timing when the optical signal is detected.

### CITATION LIST

Patent Literature
PTL 1 Unexamined Japanese Patent Publication No. S50-108838
PTL 2 Unexamined Japanese Patent Publication No. 2001-318765

### SUMMARY OF THE INVENTION

An image display device of the present invention includes an image display unit that has a plurality of scan electrodes and sustain electrodes and a plurality of data electrodes, and a driver circuit for driving the image display unit by forming one field using a plurality of subfields. In the image display device, the driver circuit displays an image on the image display unit by having an image display subfield, a y-coordinate detection subfield, and an x-coordinate detection subfield in one field. In the y-coordinate detection subfield, the driver circuit applies a y-coordinate detection voltage to the data electrodes and sequentially applies y-coordinate detection pulses to the scan electrodes. In the x-coordinate detection subfield, the driver circuit applies an x-coordinate detection voltage to the scan electrodes and sequentially applies x-coordinate detection pulses to the data electrodes. An initializing period, in which a down-ramp voltage is applied to the scan electrodes, is set in the x-coordinate detection subfield and the image display subfield. In the initializing period of the x-coordinate detection subfield, the driver circuit applies a first voltage to the data electrodes, and applies a first down-ramp voltage to the scan electrodes. In the initializing period of the image display subfield, the driver circuit applies a second voltage to the data electrodes, and applies a second down-ramp voltage to the scan electrodes. The voltage derived by subtracting an arrival voltage of the first down-ramp voltage from the first voltage is set higher than the voltage derived by subtracting an arrival voltage of the second down-ramp voltage from the second voltage.

Thus, discharge for detecting the position coordinates of the electronic pen is caused stably, and the position coordinates of the electronic pen can be detected accurately.

An image display system of the present invention includes an image display device and an electronic pen. The image display device includes an image display unit that has a plurality of scan electrodes and sustain electrodes and a plurality of data electrodes. This image display system also includes a coordinate calculating circuit and drawing circuit. The image display device displays an image on the image display unit by having an image display subfield, a y-coordinate detection subfield, and an x-coordinate detection subfield in one field. In the y-coordinate detection subfield, the image display device applies a y-coordinate detection voltage to the data electrodes and sequentially applies y-coordinate detection pulses to the scan electrodes. In the x-coordinate detection subfield, the image display device applies an x-coordinate detection voltage to the scan electrodes and sequentially applies x-coordinate detection pulses to the data electrodes. The electronic pen receives light emission occurring in the image display unit in the y-coordinate detection subfield and light emission occurring in the image display unit in the x-coordinate detection subfield, and outputs a light receiving signal. Based on the light receiving signal, the coordinate calculating circuit calculates the following coordinates:
a coordinate indicating the position of light emission received by the electronic pen, of the light emission occurring in the image display unit in the y-coordinate detection subfield; and
a coordinate indicating the position of light emission received by the electronic pen, of the light emission occurring in the image display unit in the x-coordinate detection subfield.
   The drawing circuit generates a drawing signal for displaying, on the image display unit, an image based on the coordinates calculated by the coordinate calculating circuit. The image display device displays an image on the image display unit based on the drawing signal.

Thus, discharge for detecting the position coordinates of the electronic pen is caused stably, and the position coordinates of the electronic pen can be detected accurately.

### BRIEF DESCRIPTION OF DRAWINGS

FIG. 1 is an exploded perspective view showing an example of a structure of a panel used in a plasma display apparatus in accordance with a first exemplary embodiment of the present invention.

FIG. 2 is a diagram showing an example of an electrode array of the panel used in the plasma display apparatus in accordance with the first exemplary embodiment of the present invention.

FIG. 3 is a diagram schematically showing an example of a driving voltage waveform that is to be applied to each electrode of the panel in an image display subfield in accordance with the first exemplary embodiment of the present invention.

FIG. 4 is a diagram schematically showing an example of a driving voltage waveform that is to be applied to each electrode of the panel in y-coordinate detection subfield SFy and x-coordinate detection subfield SFx in accordance with the first exemplary embodiment of the present invention.

FIG. 5 is a diagram schematically showing an example of circuit blocks constituting the plasma display apparatus and a plasma display system in accordance with the first exemplary embodiment of the present invention.

FIG. 6 is a circuit diagram schematically showing a configuration example of a scan electrode driver circuit of the plasma display apparatus in accordance with the first exemplary embodiment of the present invention.

FIG. 7 is a circuit diagram schematically showing a configuration example of a sustain electrode driver circuit of the plasma display apparatus in accordance with the first exemplary embodiment of the present invention.

FIG. 8 is a circuit diagram schematically showing a configuration example of a data electrode driver circuit of the plasma display apparatus in accordance with the first exemplary embodiment of the present invention.

FIG. 9 is a diagram schematically showing an example of the operation when the position coordinates of the electronic pen are detected in the plasma display system in accordance with the first exemplary embodiment of the present invention.

FIG. 10 is a diagram schematically showing an example of the driving voltage waveform when the position coordinates of the electronic pen are detected in the plasma display system in accordance with the first exemplary embodiment of the present invention.

FIG. 11 is a diagram schematically showing an example of the operation when a handwritten input is performed by the electronic pen in the plasma display system in accordance with the first exemplary embodiment of the present invention.

FIG. 12 is a diagram schematically showing an example of a driving voltage waveform that is to be applied to each electrode of the panel in a plasma display apparatus in accordance with a second exemplary embodiment of the present invention.

FIG. 13 is a diagram schematically showing an example of circuit blocks constituting the plasma display apparatus and a plasma display system in accordance with the second exemplary embodiment of the present invention.

### DESCRIPTION OF EMBODIMENTS

An image display device and image display system in accordance with exemplary embodiments of the present invention will be described hereinafter with reference to the accompanying drawings. In the following exemplary embodiments, as an example of the image display device and image display system, a plasma display apparatus and plasma display system that include a plasma display panel are described.

### First Exemplary Embodiment

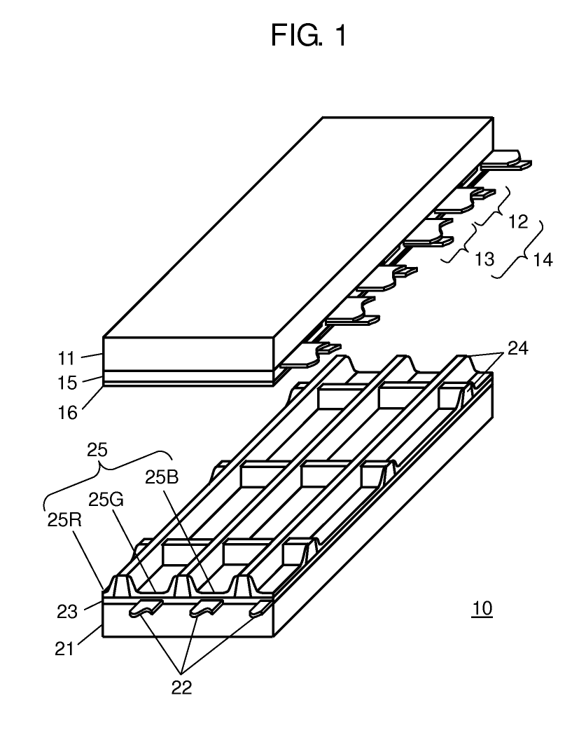

FIG. 1 is an exploded perspective view showing an example of the structure of the panel used in a plasma display apparatus in accordance with a first exemplary embodiment of the present invention.

A plurality of display electrode pairs 14 formed of scan electrodes 12 and sustain electrodes 13 is disposed on glass-made front substrate 11. Dielectric layer 15 is formed so as to cover display electrode pairs 14, and protective layer 16 is formed on dielectric layer 15. Front substrate 11 defines an image display surface on which an image is displayed.

A plurality of data electrodes 22 is formed on rear substrate 21, dielectric layer 23 is formed so as to cover data electrodes 22, and mesh barrier ribs 24 are formed on dielectric layer 23. Phosphor layers 25R for emitting light of red color (R), phosphor layers 25G for emitting light of green color (G), and phosphor layers 25B for emitting light of blue color (B) are formed on the side surfaces of barrier ribs 24 and on dielectric layer 23. Hereinafter, phosphor layers 25R, phosphor layers 25G, and phosphor layers 25B are collectively denoted with phosphor layers 25.

Front substrate 11 and rear substrate 21 are faced to each other so that display electrode pairs 14 cross data electrodes 22 with a micro space sandwiched between them, and a discharge space is disposed in the clearance between front substrate 11 and rear substrate 21. The outer periphery of the substrates is sealed by a sealing material such as glass frit. The discharge space is filled with mixed gas of neon and xenon as discharge gas, for example.

The discharge space is partitioned into a plurality of sections by barrier ribs 24. Discharge cells as light emitting elements constituting a pixel are formed in the intersection parts of display electrode pairs 14 and data electrodes 22.

Then, discharge is caused in these discharge cells and light is emitted (lighting the discharge cells) in phosphor layers 25, thereby displaying a color image on panel 10.

In panel 10, one pixel is formed of three consecutive discharge cells arranged in the extending direction of display electrode pairs 14. The three discharge cells include the following discharge cells:
a discharge cell that has phosphor layer 25R and emits light of red color (R) (hereinafter referred to as “red discharge cell” or “red pixel”);
a discharge cell that has phosphor layer 25G and emits light of green color (G) (hereinafter referred to as “green discharge cell” or “green pixel”); and
a discharge cell that has phosphor layer 25B and emits light of blue color (B) (hereinafter referred to as “blue discharge cell” or “blue pixel”).

The structure of panel 10 is not limited to the above-mentioned one, but may be a structure having striped barrier ribs, for example.

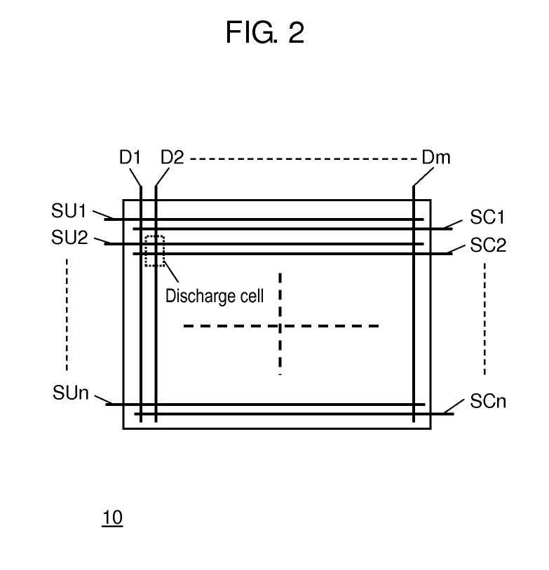

FIG. 2 is a diagram showing an example of an electrode array of the panel used in the plasma display apparatus in accordance with the first exemplary embodiment of the present invention.

Panel 10 has n scan electrodes SC1 through SCn (scan electrodes 12 in FIG. 1) and n sustain electrodes SU1 through SUn (sustain electrodes 13 in FIG. 1) both extended in a first direction, and m data electrodes D1 through Dm (data electrodes 22 in FIG. 1) extended in a second direction crossing the first direction.

Hereinafter, the first direction is called the row direction (or, horizontal direction or line direction), and the second direction is called the column direction (or, vertical direction).

One discharge cell as a light emitting element is formed in the region where a pair of scan electrode SCi (i is 1 through n) and sustain electrode SUi intersect with one data electrode Dj (j is 1 through m). In other words, on one display electrode pair 14, m discharge cells are formed and m/3 pixels are formed. Thus, m×n discharge cells are formed in the discharge space, the region having m×n discharge cells defines the image display region of panel 10. In the panel where the number of pixels is 1920×1080, for example, m is 1920×3=5760 and n is 1080.

For example, a discharge cell having data electrode Dp (p=3×q−2: q is a positive integer of m/3 or less) is coated with a red phosphor as phosphor layer 25R, and becomes a red discharge cell. A discharge cell having data electrode Dp+1 is coated with a green phosphor as phosphor layer 25G, and becomes a green discharge cell. A discharge cell having data electrode Dp+2 is coated with a blue phosphor as phosphor layer 25B, and becomes a blue discharge cell. A group of a red discharge cell, green discharge cell, and blue discharge cell that are adjacent to each other constitutes one pixel.

Next, driving voltage waveforms generated in the plasma display apparatus of the present exemplary embodiment are described.

In the present exemplary embodiment, one field includes an image display subfield group formed of a plurality of image display subfields for displaying an image on panel 10, y-coordinate detection subfield SFy, and x-coordinate detection subfield SFx. Hereinafter, an image display subfield is simply referred to also as a subfield.

Each of the image display subfields constituting an image display subfield group has an initializing period, address period, and sustain period.

In the initializing period, an initializing discharge is caused in each discharge cell, and wall charge required for the subsequent address operation is produced in a discharge cell. In addition, priming particles (charged particles for supporting the generation of discharge) required for the address operation are generated in the discharge cell. In the address period, address discharge is caused in the discharge cell to emit light. In the sustain period, sustain pulses are applied to the scan electrodes and sustain electrodes alternately, and sustain discharge is caused in the discharge cells having undergone address discharge.

The initializing operation in the initializing period includes “forced initializing operation” and “selective initializing operation”, and the generated driving voltage waveforms in them are different from each other. In the forced initializing operation, initializing discharge is forcibly caused in the discharge cells regardless of occurrence of discharge in the immediately preceding subfield. In the selective initializing operation, initializing discharge is selectively caused only in the discharge cell having undergone address discharge in the address period in the immediately preceding subfield.

The present exemplary embodiment describes the following example:
the first subfield (e.g. subfield SF1), of the plurality of subfields constituting the image display subfield group, is set as a subfield (forced initializing subfield) to undergo the forced initializing operation, and the other subfields (e.g. subfield SF2 or later) are set as subfields (selective initializing subfields) to undergo the selective initializing operation.

In the image display subfield group, a luminance weight is assigned to each subfield. In the present exemplary embodiment, the image display subfield group is constituted of eight subfields (subfields SF1 through SF8), and luminance weights of (1, 2, 3, 5, 8, 13, 21, 34) are assigned to respective subfields.

The position of the electronic pen in the image display region is represented by an x-coordinate and y-coordinate. Y-coordinate detection subfield SFy is a subfield for detecting the y-coordinate of the position of the electronic pen in the image display region, and has initializing period Piy and y-coordinate detection period Py. X-coordinate detection subfield SFx is a subfield for detecting the x-coordinate of the position of the electronic pen in the image display region, and has initializing period Pix and x-coordinate detection period Px.

The present exemplary embodiment describes an example where, in one field, the image display subfield group (e.g. subfields SF1 through SF8), y-coordinate detection subfield SFy, and x-coordinate detection subfield SFx are disposed in that sequence.

The present exemplary embodiment describes an example where, y-coordinate detection subfield SFy and x-coordinate detection subfield SFx are set in each field. However, y-coordinate detection subfield SFy and x-coordinate detection subfield SFx are not required to be set in all fields. For example, y-coordinate detection subfield SFy and x-coordinate detection subfield SFx may be disposed once for a plurality of fields in response to a video signal and the using state of the plasma display apparatus.

First, the image display subfields constituting the image display subfield group are described.

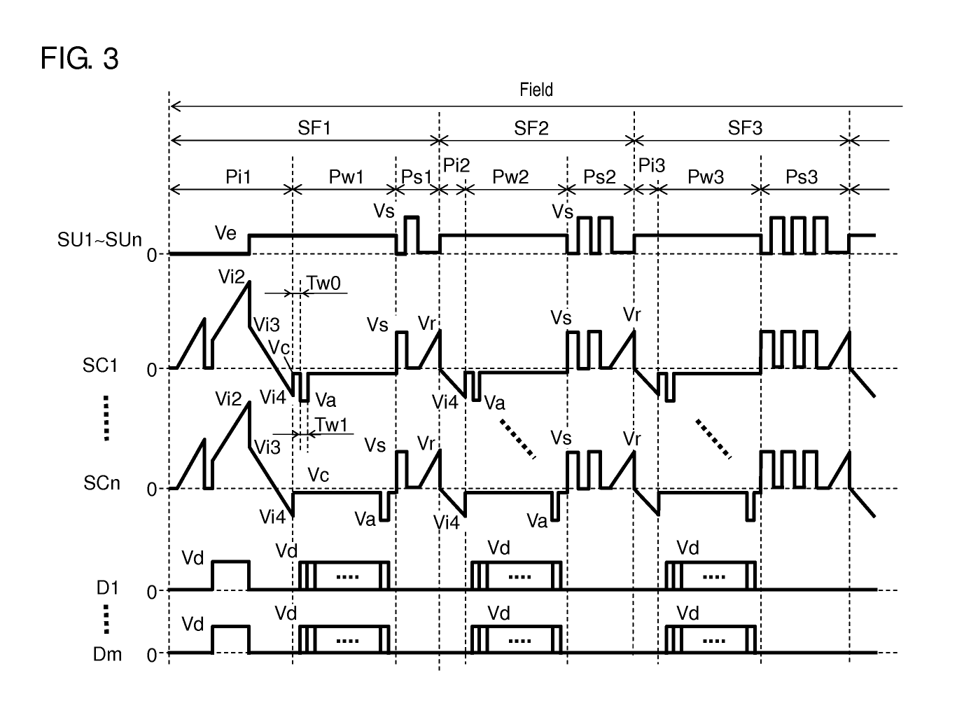

FIG. 3 is a diagram schematically showing an example of a driving voltage waveform that is to be applied to each electrode of panel 10 in the image display subfield in accordance with the first exemplary embodiment of the present invention.

FIG. 3 shows driving voltage waveforms applied to sustain electrodes SU1 through SUn, scan electrode SC1 for firstly undergoing an address operation in the address period, scan electrode SCn (e.g. scan electrode SC1080) for finally undergoing the address operation in the address period, data electrode D1, and data electrode Dm (e.g. data electrode D5760). Each of scan electrode SCi, sustain electrode SUi, and data electrode Dk discussed later means the electrode that is selected from each kind of electrode based on image data (which indicates light emission or no light emission in each subfield).

FIG. 3 shows driving voltage waveforms in each of subfields SF1 through SF3.

The waveform of the driving voltage applied to scan electrodes 22 in the initializing period differs between subfield SF1 as a forced initializing subfield and subfield SF2 and later as selective initializing subfields.

In each of subfield SF3 and later, a driving voltage waveform substantially the same as that of subfield SF2 is generated except for the number of generated sustain pulses.

First, subfield SF1 as a forced initializing subfield is described.

In the first half of initializing period Pi1 of subfield SF1 where a forced initializing operation is performed, voltage 0 (V) is applied to data electrodes D1 through Dm, and 0 (V) is applied to sustain electrodes SU1 through SUn. An up-ramp voltage, which increases from voltage 0 (V) to positive voltage Vi2 in two stages, is applied to scan electrodes SC1 through SCn. When the up-ramp voltage of the second stage is applied to scan electrodes SC1 through SCn, positive voltage Vd is applied to data electrodes D1 through Dm.

Voltage Vi2 is set at a voltage exceeding a discharge start voltage with respect to sustain electrodes SU1 through SUn.

While the up-ramp voltage increases, feeble initializing discharge continuously occurs between scan electrodes SC1 through SCn and sustain electrodes SU1 through SUn in each discharge cell, and between scan electrodes SC1 through SCn and data electrodes D1 through Dm in each discharge cell.

Negative wall voltage is accumulated on scan electrodes SC1 through SCn, and positive wall voltage is accumulated on data electrodes D1 through Dm and sustain electrodes SU1 through SUn. Priming particles for supporting the occurrence of address discharge are also generated in the discharge cells. The wall voltage on the electrodes means the voltage that is generated by the wall charge accumulated on the dielectric layers for covering the electrodes, the protective layer, or the phosphor layers.

In order to prevent occurrence of strong discharge when the up-ramp voltage of the second stage is applied to the discharge cells, preferably, the start voltage of the up-ramp voltage of the second stage is set at a value equal to or lower than the highest voltage of the up-ramp voltage of the first stage as shown in FIG. 3.

FIG. 3 shows a configuration where the up-ramp voltage is generated in two stages. However, this up-ramp voltage may have a waveform that continuously increases from voltage 0 (V) to voltage Vi2.

When positive voltage Vd is applied to data electrodes D1 through Dm while the up-ramp voltage of the second stage is applied to scan electrodes SC1 through SCn as shown in FIG. 3, the discharge between scan electrodes SC1 through SCn and sustain electrodes SU1 through SUn can be caused prior to the discharge between scan electrodes SC1 through SCn and data electrodes D1 through Dm. Therefore, the initializing discharge can be caused stably. The voltage to be applied to data electrodes D1 through Dm while the up-ramp voltage of the second stage is applied to scan electrodes SC1 through SCn may be a voltage (e.g. voltage 0 (V)) other than voltage Vd.

In the latter half of initializing period Pi1 of subfield SF1, voltage 0 (V) as a second voltage is applied to data electrodes D1 through Dm, and positive voltage Ve as a fourth voltage is applied to sustain electrodes SU1 through SUn.

A second down-ramp voltage (hereinafter, simply referred to also as “down-ramp voltage”) which gently varies from voltage Vi3 to negative voltage Vi4 is applied to scan electrodes SC1 through SCn. Voltage Vi3 is set lower than voltage Vi2 and lower than the discharge start voltage with respect to sustain electrodes SU1 through SUn. Voltage Vi4 is set at a voltage exceeding the discharge start voltage with respect to sustain electrodes SU1 through SUn.

While the down-ramp voltage is applied to scan electrodes SC1 through SCn, feeble initializing discharge continuously occurs between scan electrodes SC1 through SCn and sustain electrodes SU1 through SUn in each discharge cell, and between scan electrodes SC1 through SCn and data electrodes D1 through Dm in each discharge cell. Thus, negative wall voltage on scan electrodes SC1 through SCn and positive wall voltage on sustain electrodes SU1 through SUn are reduced, and positive wall voltage on data electrodes D1 through Dm is adjusted to a voltage appropriate to the address operation in the subsequent address period Pw1. Priming particles are also generated.

Thus, the forced initializing operation in initializing period Pi1 of the forced initializing subfield (subfield SF1) is completed. In initializing period Pi1, initializing discharge is forcibly caused in all discharge cells in the image display region of panel 10.

Next, address period Pw1 is described.

In address period Pw1 of subfield SF1, voltage 0 (V) is applied to data electrodes D1 through Dm, voltage Ve is applied to sustain electrodes SU1 through SUn, and voltage Vc is applied to scan electrodes SC1 through SCn.

Next, a negative-polarity scan pulse of negative voltage Va is applied to scan electrode SC1 of the first row. A positive-polarity address pulse of positive voltage Vd is applied to data electrode Dk of the discharge cell to emit light in the first row, of data electrodes D1 through Dm.

In the present exemplary embodiment, Tw0 is assumed to denote the period from application of voltage Vc to scan electrode SC1 to application of the scan pulse of voltage Va to scan electrode SC1. Tw1 is assumed to denote the period in which a scan pulse is applied to each of can electrodes SC1 through SCn. This period Tw1 means the width of the scan pulse, and substantially equals to the width of the address pulse applied to data electrode Dk. In the present exemplary embodiment, period Tw0 is about 50 μsec, and period Tw1 is about 1 μsec, for example.

In the discharge cell in the intersection part of data electrode Dk to which voltage Vd of the address pulse is applied and scan electrode SC1 to which voltage Va of the scan pulse is applied, discharge occurs between data electrode Dk and scan electrode SC1, and discharge also occurs between sustain electrode SU1 and scan electrode SC1. Thus, address discharge occurs in the discharge cell (to emit light) to which voltage Va of the scan pulse and voltage Vd of the address pulse are simultaneously applied.

In the discharge cell having undergone the address discharge, positive wall voltage is accumulated on scan electrode SC1, negative wall voltage is accumulated on sustain electrode SU1, and negative wall voltage is also accumulated on data electrode Dk.

Thus, the address operation in the discharge cell of the first row is completed. In the discharge cell having undergone no address pulse, the voltage in the intersection part of scan electrode SC1 and data electrode Dh (data electrodes D1 through Dm other than Dk) does not exceed the discharge start voltage, so that address discharge does not occur.

Next, a scan pulse of voltage Va is applied to scan electrode SC2 of the second row, and an address pulse of voltage Vd is applied to data electrode Dk corresponding to the discharge cell to emit light in the second row. Thus, in the discharge cell of the second row to which a scan pulse and address pulse have been applied simultaneously, address discharge occurs. In the discharge cell to which no address pulse has been applied, address discharge does not occur. Thus, the address operation in the discharge cell of the second row is performed.

A similar address operation is sequentially performed until the discharge cell of the n-th row in the sequence of scan electrode SC3, scan electrode SC4, . . . , scan electrode SCn, and thus address period Pw1 of subfield SF1 is completed. Thus, in address period Pw1, address discharge is selectively caused in the discharge cell to emit light, and wall charge required for causing sustain discharge is produced in the discharge cell.

Thus, the address operation in address period Pw1 of subfield SF1 is completed. In the present invention, the sequence of application of the scan pulses to scan electrodes SC1 through SCn is not limited to the above-mentioned one. The sequence of application of the scan pulses to scan electrodes SC1 through SCn is set optionally in response to the specification or the like of the image display device.

Next, sustain period Ps1 is described.

In sustain period Ps1 of subfield SF1, voltage 0 (V) is applied to data electrodes D1 through Dm. Sustain pulses of positive voltage Vs are applied to scan electrodes SC1 through SCn and voltage 0 (V) is applied to sustain electrodes SU1 through SUn.

Due to the application of the sustain pulses, in the discharge cell having undergone address discharge in address period Pw1 immediately before it, sustain discharge occurs between scan electrode SCi and sustain electrode SUi. Then, ultraviolet rays generated by this sustain discharge cause phosphor layers 25 to emit light.

Due to this sustain discharge, negative wall voltage is accumulated on scan electrode SCi, and positive wall voltage is accumulated on sustain electrode SUi. Positive wall voltage is also accumulated on data electrode Dk. In the discharge cell having undergone no address discharge in address period Pw1 immediately before it, sustain discharge does not occur and the wall voltage at the completion of initializing period Pi1 is kept.

Subsequently, voltage 0 (V) is applied to scan electrodes SC1 through SCn, and sustain pulses of voltage Vs are applied to sustain electrodes SU1 through SUn. In the discharge cell having undergone sustain discharge immediately before it, sustain discharge occurs again, negative wall voltage is accumulated on sustain electrode SUi, and positive wall voltage is accumulated on scan electrode SCi.

Hereinafter, similarly, as many sustain pulses as the number derived by multiplying the luminance weight by a predetermined luminance magnification are applied to scan electrodes SC1 through SCn and sustain electrodes SU1 through SUn alternately. Thus, in the discharge cell having undergone address discharge in address period Pw1 immediately before it, as many sustain discharges as the number corresponding to the luminance weight are caused, and light is emitted at a luminance corresponding to the luminance weight.

After generation of the sustain pulses in sustain period Ps1 (after the completion of the sustain operation in sustain period Ps1), in the state where voltage 0 (V) is applied to sustain electrodes SU1 through SUn and data electrodes D1 through Dm, an up-ramp voltage, which gently increases from voltage 0 (V) to voltage Vr, is applied to scan electrodes SC1 through SCn.

By setting voltage Vr to be exceed the discharge start voltage, while the up-ramp voltage is applied to scan electrodes SC1 through SCn, feeble discharge (erasing discharge) continuously occurs between sustain electrode SUi and scan electrode SCi of the discharge cell having undergone the sustain discharge.

Thus, in the state where the positive wall voltage is kept on data electrode Dk, the wall voltage on scan electrode SCi and the wall voltage on sustain electrode SUi are reduced. Thus, unnecessary wall charge in the discharge cell is erased.

The voltage applied to scan electrodes SC1 through SCn arrives at voltage Vr, then decreases to voltage 0 (V). Thus, the erasing operation is completed, and sustain period Ps1 of subfield SF1 is completed.

Thus, subfield SF1 is completed.

Next, a selective initializing subfield is described using subfield SF2 as an example.

In initializing period Pi2 of subfield SF2, voltage 0 (V) as the second voltage is applied to data electrodes D1 through Dm. Voltage Ve as the fourth voltage is applied to sustain electrodes SU1 through SUn.

A down-ramp voltage, which varies from a voltage (e.g. voltage 0 (V)) lower than the discharge start voltage to negative voltage Vi4, is applied to scan electrodes SC1 through SCn. The down-ramp voltage has a waveform that varies to the same voltage Vi4 at the same gradient as that of the down-ramp voltage generated in initializing period Pi1. Therefore, in the present exemplary embodiment, the down-ramp voltage is also set as a second down-ramp voltage.

While the down-ramp voltage is applied to scan electrodes SC1 through SCn, in the discharge cell having undergone sustain discharge in sustain period Ps1 of immediately preceding subfield SF1, feeble initializing discharge occurs between scan electrode SCi and sustain electrode SUi and between scan electrode SCi and data electrode Dk.

Due to this initializing discharge, the positive wall voltage accumulated on data electrode Dk by the immediately preceding sustain discharge is discharged by an excessive part, and hence is adjusted to a value appropriate to the address operation. The wall voltage on scan electrode SCi and the wall voltage on sustain electrode SUi are reduced. Thus, the wall voltage in the discharge cell is adjusted to a value appropriate to the address operation in subsequent address period Pw2. Furthermore, priming particles for supporting the occurrence of address discharge are generated in the discharge cell.

While, in the discharge cell having undergone no sustain discharge in sustain period Ps1 of immediately preceding subfield SF1, initializing discharge does not occur and the wall voltage at the end of initializing period Pi1 of subfield SF1 is kept.

Thus, in initializing period Pi2 of subfield SF2, a selective initializing operation is performed where initializing discharge is selectively caused in the discharge cell that has undergone the address operation in address period Pw1 of immediately preceding subfield SF1 (namely, a discharge cell having undergone the sustain operation in sustain period Ps1).

Thus, the selective initializing operation in initializing period Pi2 of subfield SF2 as the selective initializing subfield is completed.

In address period Pw2 of subfield SF2, similarly to address period Pw1 of subfield SF1, a driving voltage waveform for causing address discharge in a discharge cell to emit light is applied to each electrode. Also in subsequent sustain period Ps2, similarly in sustain period Ps1 of subfield SF1, as many sustain pulses as the number corresponding to the luminance weight are applied to scan electrodes SC1 through SCn and sustain electrodes SU1 through SUn alternately.

Also in each of subfield SF3 and later, as many sustain pulses as the number corresponding to the luminance weight are applied to scan electrodes SC1 through SCn and sustain electrodes SU1 through SUn alternately. In each of subfield SF3 and later, a driving voltage waveform similar to that in subfield SF2 is applied to each electrode except for the number of sustain pulses generated in the sustain period.

The present exemplary embodiment has described the example where subfield SF1 is set as a subfield where the forced initializing operation is performed. However, the present invention is not limited to this. Subfield SF2 or later may be set as a subfield where the forced initializing operation is performed.

The present exemplary embodiment has described the example where the forced initializing operation is performed once per field. However, the present invention is not limited to this. The forced initializing operation may be performed once for a plurality of fields.

Driving voltage waveforms in the image display subfield have been schematically described.

Next, y-coordinate detection subfield SFy and x-coordinate detection subfield SFx are described.

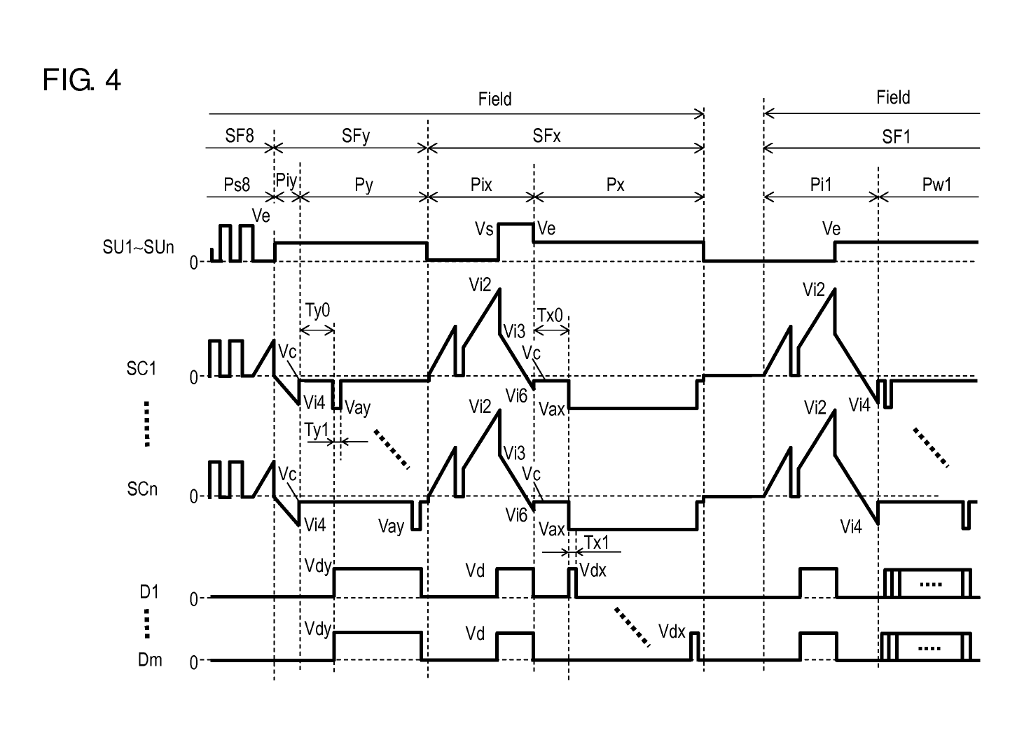

FIG. 4 is a diagram schematically showing an example of a driving voltage waveform that is to be applied to each electrode of panel 10 in a y-coordinate detection subfield SFy and x-coordinate detection subfield SFx in accordance with the first exemplary embodiment of the present invention.

FIG. 4 shows driving voltage waveforms applied to sustain electrodes SU1 through SUn, scan electrode SC1, scan electrode SCn, data electrode D1, and data electrode Dm. FIG. 4 also shows a part of sustain period Ps8 of subfield SF8 immediately before y-coordinate detection subfield SFy, and a part of subfield SF1.

The present exemplary embodiment describes the example where y-coordinate detection subfield SFy and x-coordinate detection subfield SFx are disposed after the completion of subfields SF1 through SF8 constituting an image display subfield group. However, the disposition sequence of the subfields in the present invention is not limited to this sequence. For example, the image display subfield group may be disposed after y-coordinate detection subfield SFy and x-coordinate detection subfield SFx.

First, y-coordinate detection subfield SFy is described.

In initializing period Piy of y-coordinate detection subfield SFy, a selective initializing operation is performed as in initializing period Pi2 of subfield SF2. In other words, voltage 0 (V) is applied to data electrodes D1 through Dm, voltage Ve is applied to sustain electrodes SU1 through SUn, and a down-ramp voltage, which varies from a voltage (e.g. voltage 0 (V)) lower than the discharge start voltage to negative voltage Vi4, is applied to scan electrodes SC1 through SCn.

Thus, feeble initializing discharge occurs in the discharge cell having undergone sustain discharge in sustain period Ps8 of immediately preceding subfield SF8, and the wall voltage on scan electrode SCi and the wall voltage on sustain electrode SUi are reduced. The positive wall voltage accumulated on data electrode Dk by the immediately preceding sustain discharge is discharged by an excessive part. Thus, the wall voltage in the discharge cell is adjusted to a value that is appropriate to a y-coordinate detection pattern display operation in subsequent y-coordinate detection period Py. Furthermore, priming particles for supporting the occurrence of discharge in y-coordinate detection period Py are generated in the discharge cell.

While, in the discharge cell having undergone no sustain discharge in sustain period Ps8 of immediately preceding subfield SF8, initializing discharge does not occur and the wall voltage at the end of initializing period Pi8 of subfield SF8 is kept.

Thus, the selective initializing operation in initializing period Piy of y-coordinate detection subfield SFy is completed.

Next, y-coordinate detection period Py of y-coordinate detection subfield SFy is described.

In y-coordinate detection period Py of y-coordinate detection subfield SFy, firstly, voltage Ve is applied to sustain electrodes SU1 through SUn, voltage 0 (V) is applied to data electrodes D1 through Dm, and voltage Vc is applied to scan electrodes SC1 through SCn. Then, in period Ty0 as the y-coordinate detection waiting period, this state is kept.

In the present exemplary embodiment, y-coordinate detection waiting period Ty0 is longer than period Tw0. Here, period Tw0 is the period until scan pulses are applied to scan electrodes SC1 through SCn in each of address periods Pw1 through Pw8 of the image display subfields constituting the image display subfield group of FIG. 3. Y-coordinate detection waiting period Ty0 is set at about 700 μsec, for example.

After y-coordinate detection waiting period Ty0, y-coordinate detection voltage Vdy of positive voltage is applied to data electrodes D1 through Dm, and a y-coordinate detection pulse of negative polarity of voltage Vay is applied to scan electrode SC1 of the first row. Y-coordinate detection voltage Vdy is higher than voltage 0 (V), and voltage Vay of the y-coordinate detection pulse is a negative voltage lower than voltage Vc.

In the discharge cell of the first row existing in the intersection part of data electrodes D1 through Dm to which y-coordinate detection voltage Vdy is applied and scan electrode SC1 to which the y-coordinate detection pulse of voltage Vay is applied, the following phenomena occurs:
the voltage difference of the intersection part of data electrodes D1 through Dm and scan electrode SC1 exceeds the discharge start voltage; and
discharge occurs between data electrodes D1 through Dm and scan electrode SC1 and between sustain electrode SU1 and scan electrode SC1.

Thus, discharge occurs in all of the discharge cells constituting the first row, and light is simultaneously emitted in all of them. For example, when the image display region of panel 10 is constituted of m×n discharge cells, m is 1920×3=5760, n is 1080 (namely, the number of pixels in the image display region is 1920×1080), light is simultaneously emitted in 5760 discharge cells (1920 pixels) constituting the first row. This light emission is used for y-coordinate detection.

Hereinafter, the aggregation of the discharge cells constituting one row is referred to as “discharge cell row”, and the aggregation of the pixels constituting one row is referred to as “pixel row”. In the present exemplary embodiment, the discharge cell row is substantially the same as the pixel row, and light is simultaneously emitted in the first pixel row (first discharge cell row).

In the discharge cell having undergone the discharge, positive wall voltage is accumulated on scan electrode SC1, negative wall voltage is accumulated on sustain electrode SU1, and negative wall voltage is accumulated on data electrodes D1 through Dm.

Next, in the state where y-coordinate detection voltage Vdy is applied to data electrodes D1 through Dm, a y-coordinate detection pulse of voltage Vay is applied to scan electrode SC2 of the second row. Thus, discharge occurs between data electrodes D1 through Dm and scan electrode SC2 and between sustain electrode SU2 and scan electrode SC2, and light emission for y-coordinate detection occurs in the second pixel row (second discharge cell row).

In the state where y-coordinate detection voltage Vdy is applied to data electrodes D1 through Dm, a similar operation is sequentially performed until the discharge cell of the n-th row in the sequence of scan electrode SC3, scan electrode SC4, . . . , scan electrode SCn, and light emission for y-coordinate detection is generated sequentially in third through n-th (e.g. 1080-th) pixel rows (discharge cell rows).

Thus, in y-coordinate detection period Py of y-coordinate detection subfield SFy, firstly in period Ty0 as the y-coordinate detection waiting period, voltage Vc higher than voltage Vay of the y-coordinate detection pulse is applied to scan electrodes SC1 through SCn and voltage 0 (V) lower than y-coordinate detection voltage Vdy is applied to data electrodes D1 through Dm. After y-coordinate detection waiting period Ty0, in the state where y-coordinate detection voltage Vdy of positive voltage is applied to data electrodes D1 through Dm, the y-coordinate detection pulses of negative polarity are sequentially applied to scan electrodes SC1 through SCn. Thus, light emission for y-coordinate detection is generated sequentially in the first through n-th pixel rows (discharge cell rows).

Thus, in y-coordinate detection period Py of y-coordinate detection subfield SFy, a pattern (y-coordinate detection pattern) is displayed where one horizontal line to emit light (namely, one pixel row to emit light) sequentially moves from the upper end (first pixel row) of the image display region of panel 10 to the lower end (n-th pixel row). In other words, in this y-coordinate detection pattern, light is emitted sequentially row by row in the first through n-th pixel rows in the image display region.

Then, light emission in a pixel row is received by an electronic pen. The y-coordinate of the position (x-coordinate, y-coordinate) of the electronic pen in the image display region is detected by detecting the light receiving timing, namely the time when the light emission is received by the electronic pen. This process is later described in detail.

The period in which the y-coordinate detection pattern is displayed on panel 10 is extremely short. Therefore, the possibility that the y-coordinate detection pattern is recognized by a user is low, and, even if it is recognized by the user, only extremely slight variation in luminance is recognized.

In the present exemplary embodiment, Ty1 is assumed to denote the period in which a y-coordinate detection pulse is applied to each of scan electrodes SC1 through SCn. Ty1 is about 1 μsec, for example. Therefore, when n is 1080 and y-coordinate detection waiting period Ty0 is about 700 μsec, for example, y-coordinate detection period Py is Ty0+Ty1×1080=about 1780 μsec.

Thus, y-coordinate detection period Py is completed, and y-coordinate detection subfield SFy is completed.

Next, x-coordinate detection subfield SFx is described.

In initializing period Pix of x-coordinate detection subfield SFx, a forced initializing operation is performed as in initializing period Pi1 of subfield SF1. In initializing period Pix, therefore, driving voltage waveforms similar to those in initializing period Pi1 of subfield SF1 are applied to respective electrodes. In the latter half of initializing period Pix, driving voltage waveforms having shapes different from those of the latter half of initializing period Pi1 are applied to respective electrodes.

In the first half of initializing period Pix of x-coordinate detection subfield SFx, similarly to the first half of initializing period Pi1, voltage 0 (V) is applied to data electrodes D1 through Dm and sustain electrodes SU1 through SUn. An up-ramp voltage, which increases from voltage 0 (V) to voltage Vi2 in two stages, is applied to scan electrodes SC1 through SCn. Voltage Vi2 is set at a voltage exceeding a discharge start voltage with respect to sustain electrodes SU1 through SUn.

While the up-ramp voltage increases, feeble initializing discharge continuously occurs between scan electrodes SC1 through SCn and sustain electrodes SU1 through SUn in each discharge cell, and between scan electrodes SC1 through SCn and data electrodes D1 through Dm in each discharge cell.

Negative wall voltage is accumulated on scan electrodes SC1 through SCn, and positive wall voltage is accumulated on data electrodes D1 through Dm and sustain electrodes SU1 through SUn. Priming particles for supporting the occurrence of discharge in subsequent x-coordinate detection period Px are also generated in the discharge cells.

In order to prevent occurrence of strong discharge when the up-ramp voltage of the second stage is applied to the discharge cells, preferably, the start voltage of the up-ramp voltage of the second stage is set at a value equal to or lower than the highest voltage of the up-ramp voltage of the first stage as shown in FIG. 4.

FIG. 4 shows a configuration where the up-ramp voltage is generated in two stages. However, the waveform of the up-ramp voltage may continuously increase from voltage 0 (V) to voltage Vi2. FIG. 4 shows an example where voltage 0 (V) is applied to data electrodes D1 through Dm while the up-ramp voltage of the second stage is applied to scan electrodes SC1 through SCn. However, as shown in FIG. 3, positive voltage Vd may be applied to data electrodes D1 through Dm while the up-ramp voltage of the second stage is applied to scan electrodes SC1 through SCn.

In the latter half of initializing period Pix of x-coordinate detection subfield SFx, driving voltage waveforms having shapes different from those of the latter half of initializing period Pi1 are applied to respective electrodes. Voltage Vd as the first voltage is applied to data electrodes D1 through Dm, and voltage Vs as the third voltage is applied to sustain electrodes SU1 through SUn. In the present exemplary embodiment, voltage Vd as the first voltage is set higher than voltage 0 (V) as the second voltage, and voltage Vs as the third voltage is set higher than voltage Ve as the fourth voltage.

First down-ramp voltage (hereinafter, simply referred to also as “down-ramp voltage”), which gently varies from voltage Vi3 to negative voltage Vi6, is applied to scan electrodes SC1 through SCn. In the present exemplary embodiment, negative voltage Vi6 is set higher than negative voltage Vi4. Therefore, the absolute value of voltage Vi6 is smaller than absolute value of voltage Vi4.

Voltage Vi3 is set at a voltage that is lower than voltage Vi2 and is lower than the discharge start voltage with respect to sustain electrodes SU1 through SUn. Voltage Vi6 is set at a voltage exceeding the discharge start voltage with respect to sustain electrodes SU1 through SUn.

While this down-ramp voltage is applied to scan electrodes SC1 through SCn, feeble initializing discharge continuously occurs between scan electrodes SC1 through SCn and sustain electrodes SU1 through SUn in each discharge cell, and between scan electrodes SC1 through SCn and data electrodes D1 through Dm in each discharge cell. Thus, negative wall voltage on scan electrodes SC1 through SCn and positive wall voltage on sustain electrodes SU1 through SUn are reduced, and a part of the positive wall voltage on data electrodes D1 through Dm is discharged. Priming particles are generated in the discharge cell.

The positive wall voltage remaining on data electrodes D1 through Dm is adjusted to a value lower than the positive wall voltage remaining on data electrodes D1 through Dm in initializing periods Pi1 through Pi8 of subfields SF1 through SF8 constituting the image display subfield group. This adjustment is performed in order that each driving voltage waveform generated in the latter half of initializing period Pix of x-coordinate detection subfield SFx is set as below. The detail is described later.

In the present exemplary embodiment, voltage Vi6 is set higher than voltage Vi4. Here, voltage Vi6 is the lowest voltage (arrival voltage of the first down-ramp voltage) of the first down-ramp voltage that is applied to scan electrodes SC1 through SCn in the latter half of initializing period Pix of x-coordinate detection subfield SFx. Voltage Vi4 is the lowest voltage (arrival voltage of the second down-ramp voltage) of the second down-ramp voltage that is applied to scan electrodes SC1 through SCn in initializing periods Pi1 through Pi8 of subfields SF1 through SF8 constituting the image display subfield group.

The first voltage (voltage Vd) is set higher than the second voltage (voltage 0 (V)). The first voltage (voltage Vd) is a voltage that is applied to data electrodes D1 through Dm in the latter half of initializing period Pix of x-coordinate detection subfield SFx. The second voltage (voltage 0 (V)) is a voltage that is applied to data electrodes D1 through Dm in initializing periods Pi1 through Pi8 of subfields SF1 through SF8 constituting the image display subfield group.

In the present exemplary embodiment, each voltage is set so that voltage (voltage Vd−voltage Vi6) derived by subtracting voltage Vi6 from the first voltage (voltage Vd) is higher than voltage (voltage 0 (V)−voltage Vi4) derived by subtracting voltage Vi4 from the second voltage (voltage 0 (V)).

The third voltage (voltage Vs) that is applied to sustain electrodes SU1 through SUn in the latter half of initializing period Pix of x-coordinate detection subfield SFx is set higher than the fourth voltage (voltage Ve) that is applied to sustain electrodes SU1 through SUn in initializing periods Pi1 through Pi8 of subfields SF1 through SF8 constituting the image display subfield group.

The positive wall voltage remaining on data electrodes D1 through Dm can thus be adjusted to a value that is lower than the positive wall voltage remaining on data electrodes D1 through Dm in initializing periods Pi1 through Pi8 of subfields SF1 through SF8 constituting the image display subfield group.

Thus, the forced initializing operation in initializing period Pix of x-coordinate detection subfield SFx is completed.

Next, x-coordinate detection period Px of x-coordinate detection subfield SFx is described.

In x-coordinate detection period Px of x-coordinate detection subfield SFx, voltage 0 (V) is applied to data electrodes D1 through Dm, voltage Ve is applied to sustain electrodes SU1 through SUn, and voltage Vc is applied to scan electrodes SC1 through SCn. Then, in period Tx0 as the x-coordinate detection waiting period, this state is kept.

In the present exemplary embodiment, x-coordinate detection waiting period Tx0 is longer than period Tw0. Here, period Tw0 is the period until scan pulses are applied to scan electrodes SC1 through SCn in each of address periods Pw1 through Pw8 of subfields SF1 through SF8 constituting the image display subfield group of FIG. 3. X-coordinate detection waiting period Tx0 is set at about 700 μsec, for example.

After x-coordinate detection waiting period Tx0, x-coordinate detection voltage Vax of negative voltage is applied to scan electrodes SC1 through SCn, and x-coordinate detection pulses of positive polarity of voltage Vdx are applied to data electrodes D1 through D3 of the first through third columns. Voltage Vdx of the x-coordinate detection pulse is higher than voltage 0 (V), and x-coordinate detection voltage Vax is a negative voltage lower than voltage Vc. The data electrodes D1 through D3 correspond to a red discharge cell, green discharge cell, and blue discharge cell constituting one pixel, and this pixel is disposed at the left end of the image display region, for example.

In the discharge cell existing in the intersection part of data electrodes D1 through D3 to which the x-coordinate detection pulses of voltage Vdx are applied and scan electrodes SC1 through SCn to which x-coordinate detection voltage Vax is applied, the following phenomena occurs:
the voltage difference of the intersection part of data electrodes D1 through D3 and scan electrodes SC1 through SCn exceeds the discharge start voltage; and
discharge occurs between data electrodes D1 through D3 and scan electrodes SC1 through SCn and between sustain electrodes SU1 through SUn and scan electrodes SC1 through SCn.

Thus, discharge occurs in all of the pixels constituting the first column, and light is simultaneously emitted in all of them. For example, when the image display region of panel 10 is constituted of m×n discharge cells, m is 1920×3=5760, and n is 1080 (namely, the number of pixels in the image display region is 1920×1080), light is simultaneously emitted in 1080 pixels (3 (columns)×1080 discharge cells) constituting the first column. This light emission is used for x-coordinate detection.

Hereinafter, the aggregation of the discharge cells constituting one column is referred to as “discharge cell column”. The aggregation (column of pixels) of the discharge cells constituted of three adjacent discharge cell columns is referred to as “pixel column”. In the above-mentioned operation, light is simultaneously emitted in the first pixel column (namely, first, second, and third discharge cell columns).

In the discharge cell having undergone the discharge, positive wall voltage is accumulated on scan electrodes SC1 through SCn, negative wall voltage is accumulated on sustain electrodes SU1 through SUn, and negative wall voltage is accumulated on data electrodes D1 through D3.

Next, in the state where x-coordinate detection voltage Vax is applied to scan electrodes SC1 through SCn, x-coordinate detection pulses of voltage Vdx are applied to data electrodes D4 through D6 of the fourth through sixth columns. Thus, discharge occurs between data electrodes D4 through D6 and scan electrodes SC1 through SCn and between sustain electrodes SU1 through SUn and scan electrodes SC1 through SCn, and light emission for x-coordinate detection occurs in the second pixel column (fourth, fifth, and sixth discharge cell columns).

In the state where x-coordinate detection voltage Vax is applied to scan electrodes SC1 through SCn, a similar operation is sequentially performed until the discharge cell of the m-th column every triplet of adjacent data electrodes 22 in the sequence of data electrodes D7 through D9, data electrodes D10 through D12, . . . , data electrodes Dm-2 through Dm. Light emission for x-coordinate detection is sequentially generated in each of third through final (e.g. 1920-th) pixel columns.

Thus, in x-coordinate detection period Px of x-coordinate detection subfield SFx, firstly in period Tx0 as the x-coordinate detection waiting period, voltage Vc higher than x-coordinate detection voltage Vax is applied to scan electrodes SC1 through SCn and voltage 0 (V) lower than voltage Vdx of the x-coordinate detection pulse is applied to data electrodes D1 through Dm. After x-coordinate detection waiting period Tx0, in the state where x-coordinate detection voltage Vax of negative voltage is applied to scan electrodes SC1 through SCn, the x-coordinate detection pulses of positive polarity of voltage Vdx are sequentially applied to data electrodes D1 through Dm every triplet of adjacent data electrodes. Thus, light emission for x-coordinate detection is sequentially generated in each of the first through final pixel columns.

Thus, in x-coordinate detection period Px of x-coordinate detection subfield SFx, a pattern (x-coordinate detection pattern) is displayed where one vertical line to emit light (namely, one pixel column to emit light) sequentially moves from the left end (first pixel column) of the image display region of panel 10 to the right end (m/3-th pixel column). In other words, in this x-coordinate detection pattern, light is emitted sequentially column by column in the first through final pixel columns in the image display region. In other words, in this x-coordinate detection pattern, light is emitted sequentially every triplet of adjacent discharge cell columns until the discharge cell columns move from the left end (first column) of the image display region to the right end (m-th column).

Then, light emission in a pixel column is received by an electronic pen. The x-coordinate of the position (x-coordinate, y-coordinate) of the electronic pen in the image display region is detected by detecting the light receiving timing, namely the time when the light emission is received by the electronic pen. This process is later described in detail.

The period in which the x-coordinate detection pattern is displayed on panel 10 is extremely short. Therefore, the possibility that the x-coordinate detection pattern is recognized by a user is low, and, even if it is recognized by the user, only extremely slight variation in luminance is recognized.

In the present exemplary embodiment, Tx1 is assumed to denote the period in which an x-coordinate detection pulse is applied to each of data electrodes D1 through Dm. Tx1 is about 1 μsec, for example. Therefore, when m is 1920×3 and x-coordinate detection waiting period Tx0 is about 700 μsec, x-coordinate detection period Px is Tx0+Tx1×1920=about 2620 μsec.

Thus, x-coordinate detection period Px is completed, and x-coordinate detection subfield SFx is completed.

The driving voltage waveforms in y-coordinate detection subfield SFy and x-coordinate detection subfield SFx have been described schematically.

Thus, in the present exemplary embodiment, one field includes image display subfields (e.g. subfields SF1 through SF8) constituting an image display subfield group, y-coordinate detection subfield SFy, and x-coordinate detection subfield SFx. In an image display subfield, an image corresponding to an image signal is displayed on panel 10 by generating each driving voltage waveform as discussed above. In y-coordinate detection subfield SFy, as discussed above, y-coordinate detection pulses of negative polarity are sequentially applied to scan electrodes SC1 through SCn in the state where y-coordinate detection voltage Vdy of positive voltage is applied to data electrodes D1 through Dm. Thus, linear light emission extended in the first direction is sequentially moved in the second direction. In x-coordinate detection subfield SFx, as discussed above, x-coordinate detection pulses of positive polarity are sequentially applied to data electrodes D1 through Dm in the state where x-coordinate detection voltage Vax of negative voltage is applied to scan electrodes SC1 through SCn. Thus, linear light emission extended in the second direction is sequentially moved in the first direction

Thus, the image display device of the present exemplary embodiment can stably cause discharge for detecting the position (position coordinates) of the electronic pen in the image display region while displaying an image corresponding to the image signal on panel 10.

In the present exemplary embodiment, the following voltage values are applied to respective electrodes, for example. Voltage Vi2 is 350 (V), voltage Vi4 is −175 (V), voltage Vi6 is −140 (V), voltage Va, voltage Vay, and voltage Vax are −200 (V), voltage Vc is −50 (V), voltage Vs is 205 (V), voltage Vr is 205 (V), voltage Ve is 155 (V), and voltage Vd, voltage Vdy, and voltage Vdx are 55 (V).

In the present exemplary embodiment, voltage Va, voltage Vay, and voltage Vax are set equal to each other, and voltage Vd, voltage Vdy, and voltage Vdx are set equal to each other. However, these voltages may be different from each other.

The gradient of the up-ramp voltage generated in initializing period Pi1 of subfield SF1 is about 1.5 (V/μsec). The gradients of the down-ramp voltages generated in initializing periods Pi1 through Pi8 of the image display subfields (subfields SF1 through SF8) constituting the image display subfield group, in initializing period Piy of y-coordinate detection subfield SFy, and in initializing period Pix of x-coordinate detection subfield SFx are about −2.5 (V/μsec). The gradient of the up-ramp voltage generated at the end of each of sustain periods Ps1 through Ps8 of the image display subfields (subfields SF1 through SF8) constituting the image display subfield group is about 10 (V/μsec).

In the present exemplary embodiment, specific numerical values of these voltage values and gradients are simply one example. The voltage values and gradients of the present invention are not limited to the above-mentioned numerical values. Preferably, the voltage values and gradients are set optimally based on the discharge characteristics of the panel and the specification of the plasma display apparatus.

Next, the reason why the driving voltage waveform generated in the latter half of initializing period Pix of x-coordinate detection subfield SFx is set as the above-mentioned shape in the present exemplary embodiment is described.

In the present exemplary embodiment, as discussed above, in each of address periods Pw1 through Pw8 of subfields SF1 through SF8 constituting the image display subfield group, scan pulses with an amplitude of voltage |Va−Vc| are applied to scan electrodes SC1 through SCn, and address pulses with an amplitude of voltage |Vd| are applied to data electrodes D1 through Dm.

When y-coordinate detection voltage Vdy applied to data electrodes D1 through Dm is assumed to be a wide pulse (coordinate detection pulse) in y-coordinate detection period Py of y-coordinate detection subfield SFy, coordinate detection pulses with an amplitude of voltage |Vdy| are applied to data electrodes D1 through Dm in y-coordinate detection period Py.

When x-coordinate detection voltage Vax applied to scan electrodes SC1 through SCn is assumed to be a wide pulse (coordinate detection pulse) in x-coordinate detection period Px of x-coordinate detection subfield SFx, coordinate detection pulses with an amplitude of voltage |Vax−Vc| are applied to scan electrodes SC1 through SCn in x-coordinate detection period Px.

The scan pulses to be applied to scan electrodes SC1 through SCn and the address pulses to be applied to data electrodes D1 through Dm are set to have an amplitude (voltage value) satisfying the following conditions:
discharge occurs in the discharge cell to which both pulses have been simultaneously applied; and
discharge does not occur in the discharge cell to which only one pulse has been applied.
   The coordinate detection pulses to be applied to data electrodes D1 through Dm and the coordinate detection pulses to be applied to scan electrodes SC1 through SCn are similarly set to have an amplitude (voltage value) satisfying the following conditions:
discharge occurs in the discharge cell to which both pulses have been simultaneously applied; and
discharge does not occur in the discharge cell to which only one pulse has been applied.

Wall charge accumulated on the discharge cell gradually decreases due to dark current or the like flowing in the discharge cell. The dark current means the current flowing in the discharge cell without discharge. The current amount of the dark current varies in response to the accumulation amount of wall charge and the voltage applied to the discharge cell. When the dark current increases, the reduction amount of wall charge also increases.

Therefore, in the discharge cell to which only one pulse is applied, the wall charge gradually decreases though discharge does not occur. The reduction amount of wall charge is increased by increase of the amplitude of the pulse to be applied to the discharge cell. The reduction amount of wall charge is also increased by extension of the application time of the pulse to the discharge cell. The application time of the pulse to the discharge cell is increased by increase of the number of pulse applications or increase in pulse width. Therefore, in the discharge cell where an address operation is performed at the end of the address period, the decreasing amount of wall charge is more apt to increase and the address discharge becomes more unstable than in the discharge cell where the address operation is performed at the beginning of the address period.

In address periods Pw1 through Pw8 of subfields SF1 through SF8 constituting the image display subfield group, a scan pulse is applied to each of scan electrodes SC1 through SCn only once in one address period. Therefore, the number of applications of the scan pulse to one discharge cell in one address period is one, and the length of the period in which scan pulse voltage Va is applied to the discharge cell is Tw1.

In address periods Pw1 through Pw8 of subfields SF1 through SF8 constituting the image display subfield group, an address pulse is applied to each of data electrodes D1 through Dm in response to the image signal. Therefore, a plurality of address pulses can be applied to one discharge cell in one address period. For example, in the discharge cell to which N address pulses are applied in one address period, the length of the period in which address pulse voltage Vd is applied to it is N×Tw1.

In address periods Pw1 through Pw8 of subfields SF1 through SF8 constituting the image display subfield group, preferably, reduction in wall charge is prevented in order to stably generate address discharge. In the present exemplary embodiment, the amplitude of the scan pulse is set at a relatively large value, and the amplitude of the address pulse is set at a relatively small value.

That is for the following reason:
only one scan pulse is applied to one discharge cell in one address period, and hence the amplitude of the scan pulse can be set at a relatively large value, but
a plurality of address pulses can be applied to one discharge cell in one address period, and hence it is preferable that the amplitude of the address pulses is set at a relatively small value.

In the present exemplary embodiment, the amplitude of the address pulse is set at |Vd|=55 (V), and the amplitude of the scan pulse is set at |Va−Vc|=150 (V), for example.

While, in x-coordinate detection period Px of x-coordinate detection subfield SFx, one x-coordinate detection pulse is applied to each of data electrodes D1 through Dm, and an x-coordinate detection voltage Vax is applied to scan electrodes SC1 through SCn while the x-coordinate detection pulses are applied to all of data electrodes D1 through Dm.

Therefore, in x-coordinate detection period Px of x-coordinate detection subfield SFx, the length of the period in which voltage Vdx of the x-coordinate detection pulse is applied to one discharge cell is Tx1, and the length of the period in which x-coordinate detection voltage Vax is applied to one discharge cell is Tx1×m/3.

As discussed above, in the present exemplary embodiment, voltage Vdx and voltage Vd are set equal to each other, and voltage Vax and voltage Va are set equal to each other. In x-coordinate detection period Px of x-coordinate detection subfield SFx, therefore, the period in which a pulse (x-coordinate detection pulse) having a relatively small amplitude is applied to the discharge cell is relatively short (e.g. Tx1). And, the period in which a pulse (x-coordinate detection voltage Vax) having a relatively large amplitude is applied to the discharge cell is relatively long (e.g. Tx1×m/3). This phenomenon is converse to that in each of address periods Pw1 through Pw8 of subfields SF1 through SF8 constituting the image display subfield group.

Therefore, in x-coordinate detection period Px of x-coordinate detection subfield SFx, the decreasing amount of wall charge is more apt to increase than in each of address periods Pw1 through Pw8 of subfields SF1 through SF8 constituting the image display subfield group. As a result, in the present exemplary embodiment, the driving voltage waveforms are designed so as to suppress reduction in wall charge in x-coordinate detection subfield SFx.

In the present exemplary embodiment, respective voltages are set so that the voltage that is derived by subtracting the lowest voltage (voltage Vi6) of the first down-ramp voltage applied to scan electrodes SC1 through SCn from the first voltage (voltage Vd) applied to data electrodes D1 through Dm in initializing period Pix of x-coordinate detection subfield SFx is higher than the following voltage:
the voltage that is derived by subtracting the lowest voltage (voltage Vi4) of the second down-ramp voltage applied to scan electrodes SC1 through SCn from the second voltage (voltage 0 (V)) applied to data electrodes D1 through Dm in initializing periods Pi1 through Pi8 of subfields SF1 through SF8 constituting the image display subfield group.

For example, when voltage Vd=55 (V), voltage Vi4=−175 (V), and voltage Vi6=−140 (V), voltage Vd−voltage Vi6=195 (V), and voltage 0 (V)−voltage Vi4=175 (V). Therefore, the equation of voltage Vd−voltage Vi6>voltage 0 (V)−voltage Vi4 is satisfied.

As a result, the positive wall voltage remaining on data electrodes D1 through Dm in initializing period Pix of x-coordinate detection subfield SFx is adjusted to be lower than the positive wall voltage remaining on data electrodes D1 through Dm in initializing periods Pi1 through Pi8 of subfields SF1 through SF8 constituting the image display subfield group.

Thus, by decreasing the wall voltage, dark current can be suppressed which flows when voltage Vax is applied to scan electrodes SC1 through SCn in x-coordinate detection period Px of x-coordinate detection subfield SFx. Reduction in wall charge can be suppressed by suppressing the dark current, so that reduction in wall charge in x-coordinate detection period Px can be suppressed.

In the present exemplary embodiment, therefore, it is preferable that the lowest voltage (voltage Vi6) of the first down-ramp voltage applied to scan electrodes SC1 through SCn in initializing period Pix of x-coordinate detection subfield SFx is set higher than the following voltage:
the lowest voltage (voltage Vi4) of the second down-ramp voltage applied to scan electrodes SC1 through SCn in initializing periods Pi1 through Pi8 of subfields SF1 through SF8 constituting the image display subfield group. However, the present invention is not limited to this configuration. The lowest voltage (voltage Vi6) of the first down-ramp voltage may be set equal to the lowest voltage (voltage Vi4) of the second down-ramp voltage.

In the present exemplary embodiment, before voltage Vax is applied to scan electrodes SC1 through SCn in x-coordinate detection period Px of x-coordinate detection subfield SFx, x-coordinate detection waiting period Tx0 for reducing the number of priming particles generated in initializing period Pix of x-coordinate detection subfield SFx is set. In x-coordinate detection waiting period Tx0, voltage Vc higher than voltage Vax is applied to scan electrodes SC1 through SCn and voltage 0 (V) lower than voltage Vdx is applied to data electrodes D1 through Dm.

In x-coordinate detection waiting period Tx0, the number of priming particles generated in initializing period Pix of x-coordinate detection subfield SFx decreases. When the number of priming particles decreases, the dark current can be suppressed and hence reduction in wall charge can be suppressed. Thus, comparing with the case having no x-coordinate detection waiting period Tx0, reduction in wall charge in x-coordinate detection period Px of x-coordinate detection subfield SFx can be suppressed.

Preferably, the lower limit of x-coordinate detection waiting period Tx0 is set in a range producing the above-mentioned effect. In the present exemplary embodiment, x-coordinate detection waiting period Tx0 is set at 200 μsec or more. Preferably, the upper limit of x-coordinate detection waiting period Tx0 is set in a range where the number of priming particles does not excessively decrease and all subfields are stored in one field. In the present exemplary embodiment, x-coordinate detection waiting period Tx0 is set at 1 msec or less.

In the present exemplary embodiment, x-coordinate detection subfield SFx is disposed after y-coordinate detection subfield SFy. Thus, the number of priming particles generated in sustain period Ps8 of subfield SF8 decreases in the period of y-coordinate detection subfield SFy.

Also due to this phenomenon, the dark current flowing in response to the remaining amount of the priming particles can be suppressed, and hence reduction in wall charge in x-coordinate detection period Px can be suppressed.

In the present exemplary embodiment, furthermore, the initializing operation is performed by causing not strong initializing discharge by a rectangular waveform voltage but weak initializing discharge by an up-ramp voltage and down-ramp voltage in initializing period Pix of x-coordinate detection subfield SFx. Therefore, the generation amount of priming particles can be suppressed comparing with the case where the strong initializing discharge by the rectangular waveform voltage is caused.

Also due to this phenomenon, the dark current flowing in response to the remaining amount of the priming particles can be suppressed, and hence reduction in wall charge in x-coordinate detection period Px of x-coordinate detection subfield SFx can be suppressed.

Next, the configuration of an image display system in the present exemplary embodiment is described. As an example of the image display system of the present exemplary embodiment, a plasma display system using a plasma display apparatus as the image display device is taken as an example, and the configuration of the plasma display system is described.

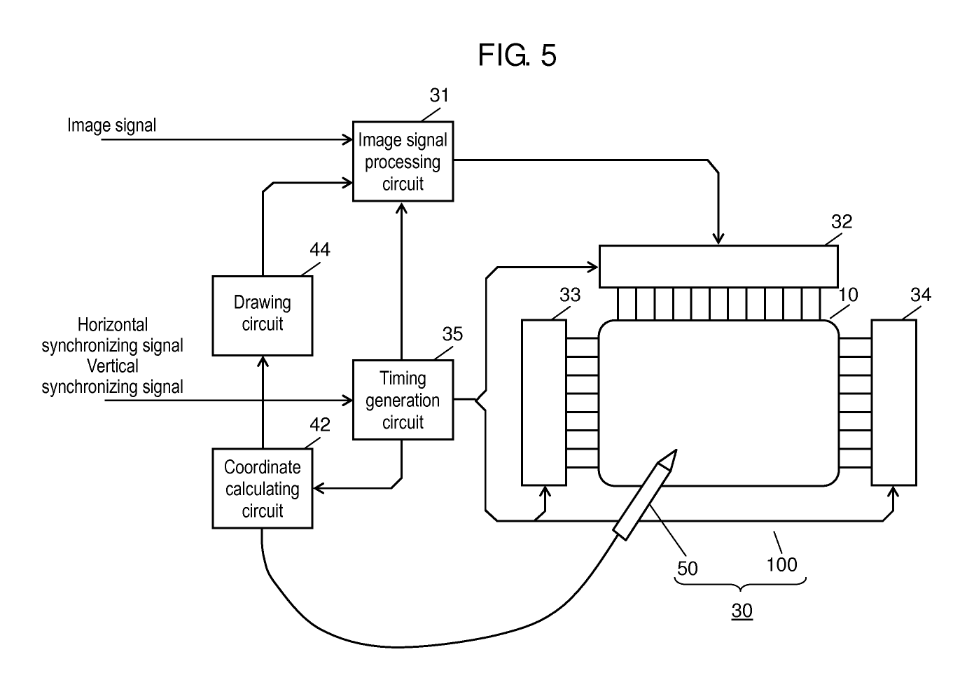

FIG. 5 is a diagram schematically showing an example of circuit blocks constituting plasma display apparatus 100 and plasma display system 30 in accordance with the first exemplary embodiment of the present invention.

Plasma display system 30 of the present exemplary embodiment includes, as components, plasma display apparatus 100 and electronic pen 50.

Plasma display apparatus 100 includes panel 10 and a driver circuit that has a plurality of subfields in one field and drives panel 10. The driver circuit has the following elements:
image signal processing circuit 31;
data electrode driver circuit 32;
scan electrode driver circuit 33;
sustain electrode driver circuit 34;
timing generation circuit 35;
coordinate calculating circuit 42;
drawing circuit 44; and
a power supply circuit (not shown) for supplying power required for each circuit block.

Image signal processing circuit 31 receives an image signal, a drawing signal output from drawing circuit 44, and a timing signal supplied from timing generation circuit 35. In order to display, on panel 10, an image obtained by combining the image signal and drawing signal, image signal processing circuit 31 combines the image signal and drawing signal, and assigns each of the gradation values of red, green, and blue (gradation value represented in one field) to each discharge cell based on the combined signal. Image signal processing circuit 31 converts the gradation values of red, green, and blue assigned to each discharge cell into image data (in this data, light emission and no light emission correspond to “1” and “0” of a digital image) that indicates lighting or no lighting in each subfield. Image signal processing circuit 31 outputs the image data (red image data, green image data, and blue image data).

Timing generation circuit 35 generates various timing signals for controlling the operations of respective circuit blocks based on a horizontal synchronizing signal and vertical synchronizing signal. Timing generation circuit 35 supplies the generated timing signals to respective circuit blocks (data electrode driver circuit 32, scan electrode driver circuit 33, sustain electrode driver circuit 34, image signal processing circuit 31, and coordinate calculating circuit 42).

Timing generation circuit 35 generates a coordinate reference signal used for calculating the position (x-coordinate, y-coordinate) of electronic pen 50 in the image display region, and outputs it to coordinate calculating circuit 42.

Data electrode driver circuit 32 generates an address pulse of voltage Vd corresponding to each of data electrodes D1 through Dm, y-coordinate detection voltage Vdy, and an x-coordinate detection pulse of voltage Vdx based on the image data output from image signal processing circuit 31 and the timing signal supplied from timing generation circuit 35. Data electrode driver circuit 32 applies the following voltage to each of data electrodes D1 through Dm:
an address pulse in each of address periods Pw1 through Pw8 of subfields SF1 through SF8 constituting the image display subfield group;
y-coordinate detection voltage Vdy in y-coordinate detection period Py of y-coordinate detection subfield SFy;
voltage Vd in initializing period Pix of x-coordinate detection subfield SFx; and
an x-coordinate detection pulse in x-coordinate detection period Px of x-coordinate detection subfield SFx.

Sustain electrode driver circuit 34 includes a sustain pulse generation circuit and a circuit (not shown in FIG. 5) for generating voltage Ve. Sustain electrode driver circuit 34 generates each driving voltage waveform based on a timing signal supplied from timing generation circuit 35, and applies it to each of sustain electrodes SU1 through SUn. Sustain electrode driver circuit 34 generates sustain pulses of voltage Vs and applies them to sustain electrodes SU1 through SUn in each of sustain periods Ps1 through Ps8 of subfields SF1 through SF8 constituting the image display subfield group. Sustain electrode driver circuit 34 applies voltage Ve to sustain electrodes SU1 through SUn in the following periods:
initializing periods Pi1 through Pi8 and address periods Pw1 through Pw8 of subfields SF1 through SF8 constituting the image display subfield group;
initializing period Piy and y-coordinate detection period Py of y-coordinate detection subfield SFy; and
x-coordinate detection period Px of x-coordinate detection subfield SFx.
   Sustain electrode driver circuit 34 applies voltage Vs to sustain electrodes SU1 through SUn in initializing period Pix of x-coordinate detection subfield SFx.

Scan electrode driver circuit 33 includes a ramp voltage generation circuit, a sustain pulse generation circuit, and a scan pulse generation circuit (not shown in FIG. 5). Scan electrode driver circuit 33 generates each driving voltage waveform based on a timing signal supplied from timing generation circuit 35, and applies it to each of scan electrodes SC1 through SCn. The ramp voltage generation circuit, based on the timing signal, generates a ramp voltage for an initializing operation to be applied to scan electrodes SC1 through SCn in initializing periods Pi1 through Pi8 of subfields SF1 through SF8 constituting the image display subfield group, in initializing period Piy of y-coordinate detection subfield SFy, and in initializing period Pix of x-coordinate detection subfield SFx. The sustain pulse generation circuit, based on the timing signal, generates sustain pulses to be applied to scan electrodes SC1 through SCn in each of sustain periods Ps1 through Ps8 of subfields SF1 through SF8 constituting the image display subfield group. The scan pulse generation circuit includes a plurality of scan electrode driver integrated circuits (scan ICs), and, based on the timing signal, generates scan pulses to be applied to scan electrodes SC1 through SCn in each of address periods Pw1 through Pw8 of subfields SF1 through SF8 constituting the image display subfield group. The scan pulse generation circuit generates voltage Vc and a y-coordinate detection pulse of voltage Vay in y-coordinate detection period Py of y-coordinate detection subfield SFy, and generates voltage Vc and x-coordinate detection voltage Vax in x-coordinate detection period Px of x-coordinate detection subfield SFx.

Electronic pen 50 is used when a user performs a handwritten input of a character or drawing in the image display region on panel 10. Electronic pen 50 is formed in a bar shape, and includes a contact switch and a light receiving element. The contact switch is disposed at the tip of electronic pen 50. When electronic pen 50 comes into contact with front substrate 11 (image display surface of panel 10) of panel 10, the contact switch detects the contact. The light receiving element receives the light emission occurring on the image display surface of panel 10 and converts it into an electric signal (light receiving signal). When the tip of electronic pen 50 is in contact with the image display surface of panel 10, electronic pen 50 converts the light emission occurring on the image display surface of panel 10 into a light receiving signal and outputs it to coordinate calculating circuit 42.

Coordinate calculating circuit 42 includes a counter for measuring time length and an arithmetic circuit (not shown in FIG. 5) for operating an output of the counter. Based on a coordinate reference signal output from timing generation circuit 35, coordinate calculating circuit 42 selectively extracts, from the light receiving signal output from electronic pen 50, a signal indicating the light emission of the y-coordinate detection pattern and a signal indicating the light emission of the x-coordinate detection pattern that are received by electronic pen 50. Then, coordinate calculating circuit 42 calculates the position (x-coordinate, y-coordinate) of electronic pen 50 in the image display region. In other words, based on the light receiving signal, coordinate calculating circuit 42 calculates the following coordinates:
a coordinate (y-coordinate) indicating the position of the light emission received by electronic pen 50, of the light emission occurring in the image display region of the image display unit in the y-coordinate detection subfield; and
a coordinate (x-coordinate) indicating the position of the light emission received by the electronic pen, of the light emission occurring in the image display region of the image display unit in the x-coordinate detection subfield.

Drawing circuit 44 includes an image memory (not shown in FIG. 5). Based on the x-coordinate and y-coordinate calculated by coordinate calculating circuit 42, drawing circuit 44 generates a drawing signal for indicating the path of electronic pen 50 in the image display region on panel 10. The drawing signal is accumulated in the image memory. Thus, a drawing signal where the present position coordinates of electronic pen 50 are added to the past path of electronic pen 50 is accumulated in the image memory. Then, drawing circuit 44 outputs the drawing signal accumulated in the image memory to image signal processing circuit 31. The drawing signal accumulated in the image memory can be partially or entirely erased by switching the mode of electronic pen 50 from “draw” to “erase”, for example.

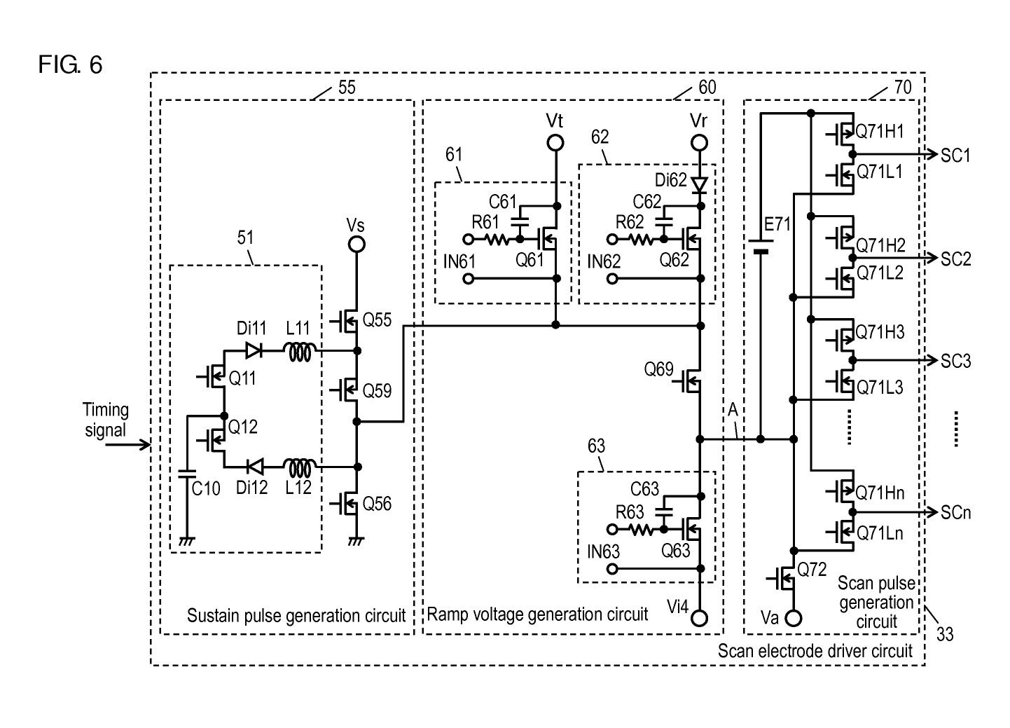

FIG. 6 is a circuit diagram schematically showing a configuration example of scan electrode driver circuit 33 of plasma display apparatus 100 in accordance with the first exemplary embodiment of the present invention.

Scan electrode driver circuit 33 includes sustain pulse generation circuit 55, ramp voltage generation circuit 60, and scan pulse generation circuit 70. Each circuit block works based on the timing signal supplied from timing generation circuit 35, but the details of the path of the timing signal are omitted in FIG. 6. The voltage input to scan pulse generation circuit 70 is denoted as “reference potential A”.

Sustain pulse generation circuit 55 includes power recovery circuit 51, switching element Q55, switching element Q56, and switching element Q59. Power recovery circuit 51 includes capacitor C10 for power recovery, switching element Q11, switching element Q12, diode Di11 and diode Di12 for back flow prevention, and inductor L11 and inductor L12 for resonance.

Power recovery circuit 51 recovers the electric power, which is accumulated in panel 10, from panel 10 by LC resonance of the inter-electrode capacity of panel 10 and inductor L12, and accumulates it in capacitor C10. Power recovery circuit 51 supplies the recovered electric power from capacitor C10 to panel 10 again by LC resonance of the inter-electrode capacity of panel 10 and inductor L11, and reuses it as electric power for driving scan electrodes SC1 through SCn.

Switching element Q55 clamps scan electrodes SC1 through SCn on voltage Vs, and switching element Q56 clamps scan electrodes SC1 through SCn on voltage 0 (V). Switching element Q59 is a separation switch and prevents current from flowing back via a parasitic diode or the like of a switching element constituting scan electrode driver circuit 33.

Sustain pulse generation circuit 55 thus generates sustain pulses of voltage Vs to be applied to scan electrodes SC1 through SCn.

Scan pulse generation circuit 70 includes switching elements Q71H1 through Q71Hn, switching elements Q71L1 through Q71Ln, switching element Q72, a power supply for generating negative voltage Va, and power supply E71 for generating voltage Vp. Then, voltage Vc (Vc=Va+Vp) is generated by adding voltage Vp to reference potential A of scan pulse generation circuit 70, and voltage Va and voltage Vc are applied to scan electrodes SC1 through SCn while switching between voltage Va and voltage Vc is performed, thereby generating scan pulses. For example, when voltage Va is −200 (V) and voltage Vp is 150 (V), voltage Vc becomes −50 (V).

Scan pulse generation circuit 70 sequentially applies scan pulses to scan electrodes SC1 through SCn with timings of FIG. 3 and FIG. 4. Scan pulse generation circuit 70 outputs the output voltage of sustain pulse generation circuit 55 in the sustain period as it is. In other words, the voltage of reference potential A is output to scan electrodes SC1 through SCn.

With timings of FIG. 4, scan pulse generation circuit 70 generates voltage Vc and a y-coordinate detection pulse of voltage Vay (=Va) in y-coordinate detection period Py of y-coordinate detection subfield SFy, or generates voltage Vc and an x-coordinate detection voltage Vax (=Va) in x-coordinate detection period Px of x-coordinate detection subfield SFx, and applies them to scan electrodes SC1 through SCn.

Ramp voltage generation circuit 60 includes Miller integrating circuit 61, Miller integrating circuit 62, and Miller integrating circuit 63, and generates the ramp voltages of FIG. 3 and FIG. 4.

Miller integrating circuit 61 includes transistor Q61, capacitor C61, and resistor R61. Miller integrating circuit 61 generates an up-ramp voltage which gently increases to voltage Vt (=Vi2) by applying a fixed voltage to input terminal IN61 (applying a fixed voltage difference between two circles shown as input terminal IN61). Here, the up-ramp voltage includes an up-ramp voltage generated in initializing period Pi1 of subfield SF1, which is included in the image display subfield group, and an up-ramp voltage generated in initializing period Pix of x-coordinate detection subfield SFx.

Voltage Vt may be set so that voltage Vi2 is equal to a voltage derived by adding voltage Vp to voltage Vt. In this configuration, when Miller integrating circuit 61 is operated, switching element Q72 and switching elements Q71L1 through Q71Ln are set at OFF, and switching elements Q71H1 through Q71Hn are set at ON. Thus, the up-ramp voltage for an initializing operation can be generated by adding voltage Vp of power supply E71 to the up-ramp voltage generated by Miller integrating circuit 61.

Miller integrating circuit 62 includes transistor Q62, capacitor C62, resistor R62, and diode D162 for back flow prevention. Miller integrating circuit 62 generates an up-ramp voltage which gently increases to voltage Vr by applying a fixed voltage to input terminal IN62 (applying a fixed voltage difference between two circles shown as input terminal IN62). Here, the up-ramp voltage is generated at the end of sustain periods Ps1 through Ps8 of subfields SF1 through SF8 constituting the image display subfield group.

Miller integrating circuit 63 includes transistor Q63, capacitor C63, and resistor R63. Miller integrating circuit 63 generates a down-ramp voltage which gently varies to voltage Vi4 by applying a fixed voltage to input terminal IN63 (applying a fixed voltage difference between two circles shown as input terminal IN63). Here, the down-ramp voltage includes a down-ramp voltage generated in each of initializing periods Pi1 through Pi8 of subfields SF1 through SF8 constituting the image display subfield group and a down-ramp voltage generated in initializing period Piy of y-coordinate detection subfield SFy. In initializing period Pix of x-coordinate detection subfield SFx, a down-ramp voltage (the down-ramp voltage generated in initializing period Pix) which varies to voltage Vi6 is generated by stopping the operation of Miller integrating circuit 63 at the time when the down-ramp voltage arrives at voltage Vi6.

Switching element Q69 is a separation switch, and prevents current from flowing back via a parasitic diode or the like of a switching element constituting scan electrode driver circuit 33.

These switching elements and transistors can be formed using a generally known semiconductor device such as a metal oxide semiconductor field effect transistor (MOSFET) or an insulated gate bipolar transistor (IGBT). These switching elements and transistors are controlled in response to the timing signals that are generated by timing generation circuit 35 and correspond to the switching elements and transistors.

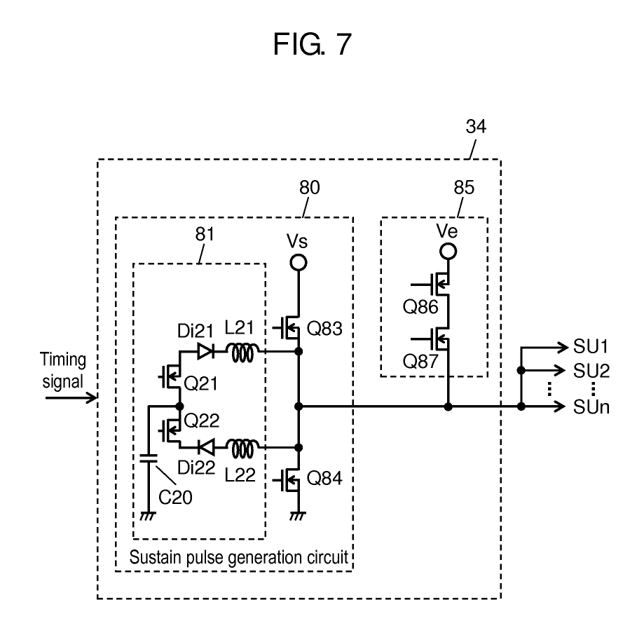

FIG. 7 is a circuit diagram schematically showing a configuration example of sustain electrode driver circuit 34 of plasma display apparatus 100 in accordance with the first exemplary embodiment of the present invention.

Sustain electrode driver circuit 34 includes sustain pulse generation circuit 80 and fixed voltage generation circuit 85. Each circuit block works based on the timing signal supplied from timing generation circuit 35, but the details of the path of the timing signal are omitted in FIG. 7.

Sustain pulse generation circuit 80 includes power recovery circuit 81, switching element Q83, and switching element Q84. Power recovery circuit 81 includes capacitor C20 for power recovery, switching element Q21, switching element Q22, diode Di21 and diode Di22 for back flow prevention, and inductor L21 and inductor L22 for resonance.

Power recovery circuit 81 recovers the electric power, which is accumulated in panel 10, from panel 10 by LC resonance of the inter-electrode capacity of panel 10 and inductor L22, and accumulates it in capacitor C20. Power recovery circuit 81 supplies the recovered electric power from capacitor C20 to panel 10 again by LC resonance of the inter-electrode capacity of panel 10 and inductor L21, and reuses it as electric power for driving sustain electrodes SU1 through SUn.

Switching element Q83 clamps sustain electrodes SU1 through SUn on voltage Vs, and switching element Q84 clamps sustain electrodes SU1 through SUn on voltage 0 (V).

Sustain pulse generation circuit 80 thus generates sustain pulses of voltage Vs to be applied to sustain electrodes SU1 through SUn. Sustain pulse generation circuit 80 applies voltage Vs to sustain electrodes SU1 through SUn in initializing period Pix of x-coordinate detection subfield SFx.

Fixed voltage generation circuit 85 includes switching element Q86 and switching element Q87. Fixed voltage generation circuit 85 applies voltage Ve to sustain electrodes SU1 through SUn in the following periods:
initializing periods Pi1 through Pi8 and address periods Pw1 through Pw8 of subfields SF1 through SF8 constituting the image display subfield group;
initializing period Piy and y-coordinate detection period Py of y-coordinate detection subfield SFy; and
x-coordinate detection period Px of x-coordinate detection subfield SFx.

These switching elements can be formed using a generally known element such as a MOSFET or IGBT. These switching elements are controlled in response to the timing signals that are generated by timing generation circuit 35 and correspond to the respective switching elements.

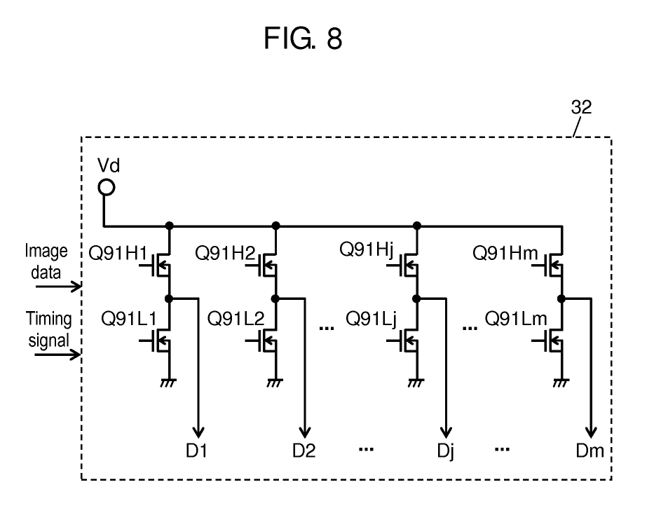

FIG. 8 is a circuit diagram schematically showing a configuration example of data electrode driver circuit 32 of plasma display apparatus 100 in accordance with the first exemplary embodiment of the present invention.

Data electrode driver circuit 32 works based on the image data supplied from image signal processing circuit 31 and the timing signal supplied from timing generation circuit 35, but the details of the path of these signals are omitted in FIG. 8.

Data electrode driver circuit 32 includes switching elements Q91H1 through Q91Hm, and switching elements Q91L1 through Q91Lm. Voltage 0 (V) is applied to data electrode Dj by setting switching element Q91Lj at ON, and voltage Vd is applied to data electrode Dj by setting switching element Q91Hj at ON. Data electrode driver circuit 32 thus applies the following voltage to each of data electrodes D1 through Dm:
an address pulse of voltage Vd in each of address periods Pw1 through Pw8 of subfields SF1 through SF8 constituting the image display subfield group;
y-coordinate detection voltage Vdy (=Vd) in y-coordinate detection period Py of y-coordinate detection subfield SFy;
voltage Vd in initializing period Pix of x-coordinate detection subfield SFx; and
an x-coordinate detection pulse of voltage Vdx (=Vd) in x-coordinate detection period Px of x-coordinate detection subfield SFx.

Next, the operation of a plasma display system as an example of the image display system of the present exemplary embodiment is described.

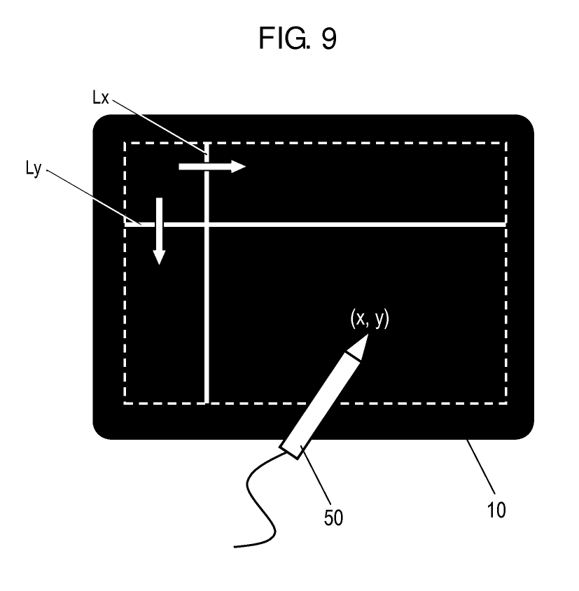

FIG. 9 is a diagram schematically showing an example of the operation when the position coordinates of electronic pen 50 are detected in plasma display system 30 in accordance with the first exemplary embodiment of the present invention.

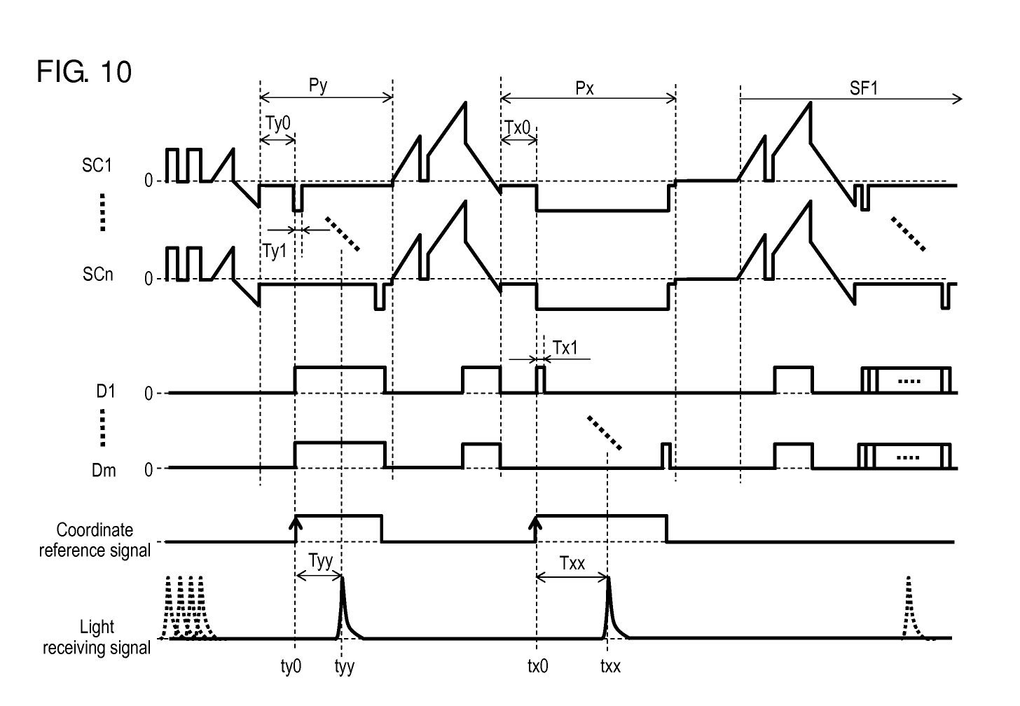

FIG. 10 is a diagram schematically showing an example of the driving voltage waveform when the position coordinates of electronic pen 50 are detected in plasma display system 30 in accordance with the first exemplary embodiment of the present invention.

FIG. 10 shows a driving voltage waveform applied to each of scan electrode SC1, scan electrode SCn, data electrode D1, and data electrode Dm, a coordinate reference signal input to coordinate calculating circuit 42, and a light receiving signal output from electronic pen 50 in y-coordinate detection subfield SFy, which follows subfield SF8 of the image display subfield group, and x-coordinate detection subfield SFx. In FIG. 10, driving voltage waveforms applied to sustain electrodes SU1 through SUn are omitted.

Timing generation circuit 35 generates a coordinate reference signal and outputs it to coordinate calculating circuit 42. As shown in FIG. 10, the coordinate reference signal has rising edges at the following times:
time ty0 after a lapse of y-coordinate detection waiting period Ty0 from the beginning of y-coordinate detection period Py of y-coordinate detection subfield SFy; and
time tx0 after a lapse of x-coordinate detection waiting period Tx0 from the beginning of x-coordinate detection period Px of x-coordinate detection subfield SFx.

In y-coordinate detection period Py of y-coordinate detection subfield SFy, a y-coordinate detection pattern where linear light emission extended in the first direction (row direction) sequentially moves in the second direction (column direction) is displayed on panel 10. Thus, in the image display region of panel 10, one horizontal line Ly that sequentially moves from the upper end (first row) of the image display region to the lower end (n-th row) thereof is displayed as shown in FIG. 9.

When the tip of electronic pen 50 is in contact with the image display surface of panel 10 at a position of “coordinates (x, y)”, the light receiving element of electronic pen 50 receives light emission of horizontal line Ly at time tyy when horizontal line Ly passes coordinates (x, y). Thus, at time tyy, electronic pen 50 outputs a light receiving signal indicating that the light receiving element has received the light emission of horizontal line Ly, as shown in FIG. 10.

In subsequent x-coordinate detection period Px of x-coordinate detection subfield SFx, an x-coordinate detection pattern where linear light emission extended in the second direction (column direction) sequentially moves in the first direction (row direction) is displayed on panel 10. Thus, in the image display region of panel 10, one vertical line Lx that sequentially moves from the left end (first pixel column) of the image display region to the right end (m/3-th pixel column) thereof is displayed as shown in FIG. 9.

When the tip of electronic pen 50 is in contact with the image display surface of panel 10 at a position of “coordinates (x, y)”, the light receiving element of electronic pen 50 receives light emission of vertical line Lx at time txx when vertical line Lx passes the coordinates (x, y). Thus, at time txx, electronic pen 50 outputs a light receiving signal indicating that the light receiving element has received the light emission of horizontal line Lx, as shown in FIG. 10.

Coordinate calculating circuit 42 of FIG. 5 measures period Tyy from time ty0 to time tyy using a built-in counter based on the coordinate reference signal output from timing generation circuit 35 in y-coordinate detection period Py of y-coordinate detection subfield SFy and the light receiving signal output from electronic pen 50. The built-in arithmetic circuit divides period Tyy by period Ty1. This dividing result becomes the y-coordinate of the position of electronic pen 50 in the image display region. Thus, coordinate calculating circuit 42 calculates the y-coordinate.

Coordinate calculating circuit 42 measures period Txx from time tx0 to time txx using a built-in counter based on the coordinate reference signal output from timing generation circuit 35 in x-coordinate detection period Px of x-coordinate detection subfield SFx and the light receiving signal output from electronic pen 50. The built-in arithmetic circuit divides period Txx by period Tx1. This dividing result becomes the x-coordinate of the position of electronic pen 50 in the image display region. Thus, coordinate calculating circuit 42 calculates the x-coordinate.

Coordinate calculating circuit 42 of the present exemplary embodiment calculates the position (coordinates (x, y)) of electronic pen 50 in the image display region.

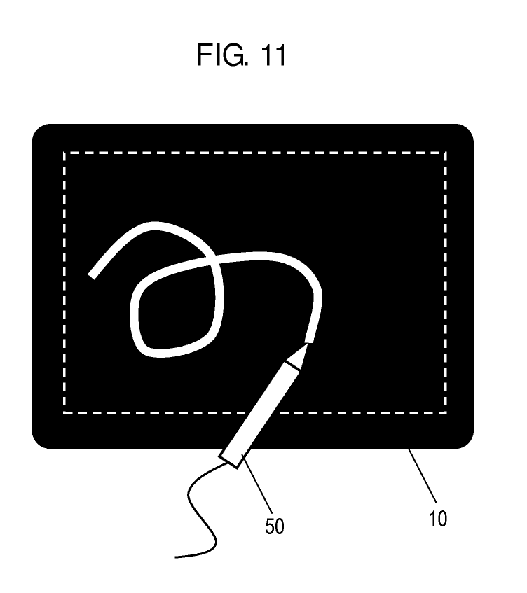

FIG. 11 is a diagram schematically showing an example of the operation when a handwritten input is performed by electronic pen 50 in plasma display system 30 in accordance with the first exemplary embodiment of the present invention.

Drawing circuit 44 writes, into the image memory, a drawing signal of a drawing pattern (e.g. pattern such as a black circle) of a predetermined color and size so as to center the pixel corresponding to the coordinates (x, y) calculated by coordinate calculating circuit 42.

When a user moves electronic pen 50 while the tip of electronic pen 50 is in contact with the image display surface of panel 10, the coordinates (x, y) calculated by coordinate calculating circuit 42 also vary in response to the movement of electronic pen 50.

While varying the position of the drawing pattern in response to the varying coordinates (x, y), drawing circuit 44 sequentially writes, into the image memory, drawing signals corresponding to the drawing pattern whose position moves.

Thus, the drawing signals indicating the path of electronic pen 50 are accumulated in the image memory of drawing circuit 44. The drawing signals accumulated in the image memory are read per field, and are output to image signal processing circuit 31.

In order to erase the path of electronic pen 50 shown on panel 10, for example, the mode of electronic pen 50 is switched from “draw” to “erase”, and the path of electronic pen 50 shown on panel 10 is traced again. Thus, the drawing signals accumulated in the image memory are partially or entirely erased.

Image signal processing circuit 31 combines the image signal and the drawing signal output from drawing circuit 44, and generates image data based on the combined signal. On panel 10, as shown in FIG. 11, an image obtained by adding an image (drawing that is hand-written using electronic pen 50) indicating the path of electronic pen 50 to the image signal is displayed.

The number of subfields constituting one field, the disposition sequence of the subfields, and the luminance weight of each subfield in the present invention are not limited to the above-mentioned configuration. For example, x-coordinate detection subfield SFx may be disposed before y-coordinate detection subfield SFy, and the image display subfield group may be disposed after y-coordinate detection subfield SFy and x-coordinate detection subfield SFx. Preferably, they are set optimally in response to the specification or the like of the plasma display apparatus.

### Second Exemplary Embodiment

The second exemplary embodiment describes a configuration where wireless communication is performed between an electronic pen and a plasma display apparatus.

A plasma display system of the present exemplary embodiment calculates the position coordinates of the electronic pen inside the electronic pen, and transmits data of the calculated position coordinates from the electronic pen to the plasma display apparatus by wireless communication.

Firstly, timing detection subfield SFo of the present exemplary embodiment is described schematically. Next, the configuration of the plasma display system of the present exemplary embodiment is described.

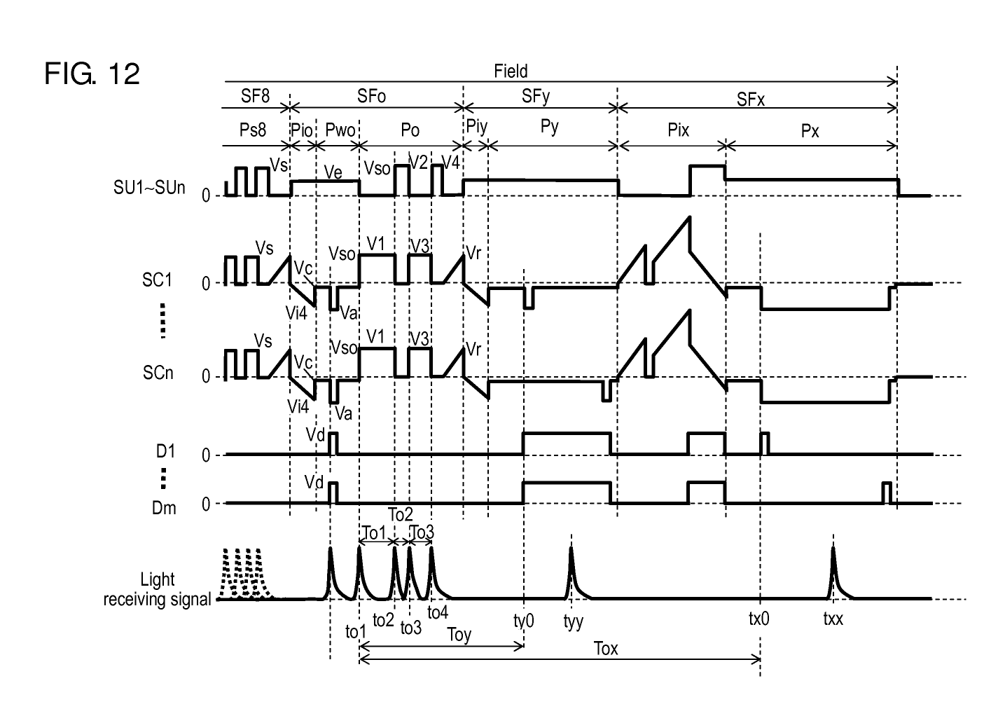

FIG. 12 is a diagram schematically showing an example of a driving voltage waveform that is to be applied to each electrode of panel 10 used in plasma display apparatus 110 in accordance with the second exemplary embodiment of the present invention.

FIG. 12 shows driving voltage waveforms applied to sustain electrodes SU1 through SUn, scan electrode SC1, scan electrode SCn, data electrode D1, and data electrode Dm, and a light receiving signal detected by the electronic pen. FIG. 12 schematically shows an example of the driving voltage waveforms when the position coordinates of the electronic pen are detected in the present exemplary embodiment.

The plasma display system of the present exemplary embodiment has, in one field, image display subfields (e.g. subfields SF1 through SF8) constituting an image display subfield group, timing detection subfield SFo, y-coordinate detection subfield SFy, and x-coordinate detection subfield SFx.

The image display subfields of the present exemplary embodiment have substantially the same configuration and operation as those of the image display subfields of the first exemplary embodiment, so that the descriptions of them are omitted.

Timing detection subfield SFo has initializing period Pio, address period Pwo, and timing detection period Po.

In initializing period Pio of timing detection subfield SFo, the selective initializing operation shown in the first exemplary embodiment is performed. In other words, voltage 0 (V) is applied to data electrodes D1 through Dm, voltage Ve is applied to sustain electrodes SU1 through SUn, and a down-ramp voltage, which varies from a voltage (e.g. voltage 0 (V)) lower than the discharge start voltage to voltage Vi4, is applied to scan electrodes SC1 through SCn.

While the down-ramp voltage is applied to scan electrodes SC1 through SCn, initializing discharge occurs in the discharge cell having undergone sustain discharge in sustain period Ps8 of immediately preceding subfield SF8.

In address periods Pwo of timing detection subfield SFo, voltage 0 (V) is applied to data electrodes D1 through Dm, voltage Ve is applied to sustain electrodes SU1 through SUn, and voltage Vc is applied to scan electrodes SC1 through SCn.

Next, address pulses of voltage Vd are simultaneously applied to data electrodes D1 through Dm, and scan pulses of voltage Va are simultaneously applied to scan electrodes SC1 through SCn. Thus, address discharge occurs simultaneously in all discharge cells.

In timing detection period Po of timing detection subfield SFo, a plurality of light emissions (light emissions for timing detection) as a reference when the position coordinates are calculated by the electronic pen is caused in panel 10. In other words, at predetermined time intervals (for example, period To1, period To2, and period To3 in the present exemplary embodiment), a plurality of timing detection discharges (for example, four discharges in the present exemplary embodiment) are caused in all discharge cells in the image display region of panel 10.

Specifically, at time to1, voltage 0 (V) is applied to sustain electrodes SU1 through SUn, and timing detection pulses V1 of voltage Vso are applied to scan electrodes SC1 through SCn. Thus, the first timing detection discharge occurs in all discharge cells, and light is emitted on the whole surface of the image display surface of panel 10 (first light emission for timing detection).

Next, at time to2 after a lapse of period To1 from time to1, voltage 0 (V) is applied to scan electrodes SC1 through SCn, and timing detection pulses V2 of voltage Vso are applied to sustain electrodes SU1 through SUn. Thus, second timing detection discharge occurs in all discharge cells, and light is emitted on the whole surface of the image display surface of panel 10 (second light emission for timing detection).

Next, at time to3 after a lapse of period To2 from time to 2, voltage 0 (V) is applied to sustain electrodes SU1 through SUn, and timing detection pulses V3 of voltage Vso are applied to scan electrodes SC1 through SCn. Thus, third timing detection discharge occurs in all discharge cells, and light is emitted on the whole surface of the image display surface of panel 10 (third light emission for timing detection).

Next, at time to4 after a lapse of period To3 from time to 3, voltage 0 (V) is applied to scan electrodes SC1 through SCn, and timing detection pulses V4 of voltage Vso are applied to sustain electrodes SU1 through SUn. Thus, fourth timing detection discharge occurs in all discharge cells, and light is emitted on the whole surface of the image display surface of panel 10 (fourth light emission for timing detection).

Thus, in timing detection subfield SFo, a plurality of timing detection discharges (for example, four discharges in the present exemplary embodiment) are caused at the predetermined intervals (for example, period To1, period To2, and period To3 in the present exemplary embodiment), and a plurality of (e.g. four) light emissions are caused on the image display surface of panel 10 at the predetermined time intervals (for example, period To1, period To2, and period To3).

Then, on detecting a plurality of (e.g. four) light emissions caused at the predetermined time intervals (for example, period To1, period To2, and period To3), the electronic pen generates a coordinate reference signal (the details are described later).

In timing detection period Po of timing detection subfield SFo, after generation of timing detection pulses V4 (at the end of timing detection period Po), an operation similar to the erasing operation of the first exemplary embodiment is performed. In other words, in the state where voltage 0 (V) is applied to sustain electrodes SU1 through SUn and data electrodes D1 through Dm, an up-ramp voltage, which gently increases from voltage 0 (V) to voltage Vr, is applied to scan electrodes SC1 through SCn. Thus, feeble erasing discharge occurs in all discharge cells.

Thus, timing detection period Po of timing detection subfield SFo is completed, and timing detection subfield SFo is completed.

Subsequently, y-coordinate detection subfield SFy and x-coordinate detection subfield SFx are disposed.

Y-coordinate detection subfield SFy and x-coordinate detection subfield SFx of the present exemplary embodiment have substantially the same configuration and operation as those of y-coordinate detection subfield SFy and x-coordinate detection subfield SFx of the first exemplary embodiment, so that the descriptions of them are omitted.

In the present exemplary embodiment, voltage Vso is set equal to voltage Vs, and voltage Vso is about 205 (V), for example. However, voltage Vso may be different from voltage Vs. Voltage Vso is required to be a voltage at which timing detection discharge occurs.

Thus, in the present exemplary embodiment, one field includes image display subfields (e.g. subfield SF1 through SF8) constituting an image display subfield group, timing detection subfield SFo, y-coordinate detection subfield SFy, and x-coordinate detection subfield SFx.

In timing detection subfield SFo, timing detection pulses are applied to scan electrodes SC1 through SCn and sustain electrodes SU1 through SUn alternately at the predetermined time intervals (for example, period To1, period To2, and period To3). Thus, a plurality of (e.g. four) timing detection discharges are caused at the predetermined time intervals (for example, period To1, period To2, and period To3), and a plurality of (e.g. four) light emissions are generated on the image display surface of panel 10. For example, period To1 is about 40 μsec, period To2 is about 20 μsec, and period To3 is about 30 μsec. However, the periods of the present invention are not limited to the above-mentioned numerical values. Preferably, the periods are set appropriately in response to the specification or the like of the plasma display system.

Next, the configuration of the plasma display system as an example of the image display system of the present exemplary embodiment is described.

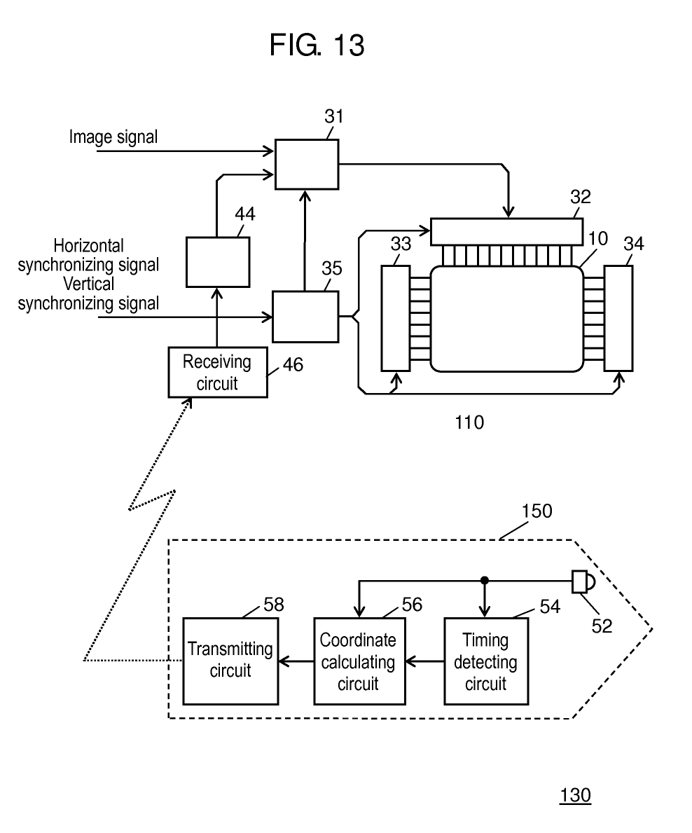

FIG. 13 is a diagram schematically showing an example of circuit blocks constituting plasma display apparatus 110 and plasma display system 130 in accordance with the second exemplary embodiment of the present invention.

In the present exemplary embodiment, circuit blocks that have substantially the same configuration and operation as those of the circuit blocks described in the first exemplary embodiment are denoted with the same reference marks as those of the first exemplary embodiment, and the descriptions of them are omitted.

Plasma display system 130 of the present exemplary embodiment includes, as components, plasma display apparatus 110 and electronic pen 150.

Plasma display apparatus 110 includes panel 10 and a driver circuit for driving panel 10. The driver circuit includes the following elements:
image signal processing circuit 31;
data electrode driver circuit 32;
scan electrode driver circuit 33;
sustain electrode driver circuit 34;
timing generation circuit 35;
drawing circuit 44;
receiving circuit 46; and
a power supply circuit (not shown) for supplying power required for each circuit block.

Electronic pen 150 is formed in a bar shape, and includes light receiving element 52, timing detecting circuit 54, coordinate calculating circuit 56, and transmitting circuit 58. Electronic pen 150 also includes a contact switch (not shown in FIG. 13). The contact switch is disposed at the tip of electronic pen 150. When electronic pen 150 comes into contact with front substrate 11 (image display surface of panel 10) of panel 10, the contact switch detects the contact.

Light receiving element 52 receives light emission occurring on the image display surface of panel 10 and converts it into an electric signal (light receiving signal). Light receiving element 52 outputs the light receiving signal to timing detecting circuit 54 and coordinate calculating circuit 56.

Timing detecting circuit 54 performs the following operation in the period in which the contact switch detects the contact.

Timing detecting circuit 54, based on the light receiving signal, detects light emission for timing detection (light emission caused by timing detection discharge) occurring in timing detection period Po of timing detection subfield SFo. Specifically, timing detecting circuit 54 measures time intervals of a plurality of (e.g. four) light emissions using a timer (not shown in FIG. 13) included in timing detecting circuit 54. Timing detecting circuit 54 determines whether the time intervals match with the predetermined time intervals (for example, period To1, period To2, and period To3).

Thus, timing detecting circuit 54, based on the light receiving signal, detects a plurality of light emissions occurring at the predetermined time intervals. In the example of FIG. 12, timing detecting circuit 54 detects four continuous light emissions occurring at the following intervals: sequentially, period To1, period To2, and period To3.

Timing detecting circuit 54 generates a coordinate reference signal with reference to one of the plurality of (e.g. four) continuous light emissions. For example, in the example of FIG. 12, the coordinate reference signal is generated with reference to the light emission occurring at time to1 of timing detection period Po. The coordinate reference signal (not shown in FIG. 12) is substantially the same as that of FIG. 10, and has rising edges at time ty0 and time tx0.

In plasma display apparatus 110 of the present exemplary embodiment, period Toy from time to1 to time ty0 is previously determined, and period Tox from time to1 to time tx0 is previously determined. Time to1 is a time at which first timing detection pulse V1 is applied to scan electrodes SC1 through SCn in timing detection period Po of timing detection subfield SFo. Time ty0 is a time at which a y-coordinate detection pulse is applied to scan electrode SC1 of the first row in y-coordinate detection period Py of y-coordinate detection subfield SFy. Time tx0 is a time at which x-coordinate detection pulses are applied to data electrodes D1 through D3 corresponding to the first pixel column in x-coordinate detection period Px of x-coordinate detection subfield SFx.

Therefore, when time to1 is determined, a coordinate reference signal that has rising edges at time ty0 and time tx0 can be generated. Timing detecting circuit 54 of the present exemplary embodiment, based on the light receiving signal, determines time to1 by detecting a plurality of light emissions for timing detection occurring at the predetermined time intervals in timing detection period Po. A timer (not shown in FIG. 13) included in timing detecting circuit 54 is operated with reference to time to1, and the coordinate reference signal that has rising edges at time ty0 and time tx0 is generated.

Then, timing detecting circuit 54 outputs the coordinate reference signal to coordinate calculating circuit 56.

The present exemplary embodiment describes the example where the coordinate reference signal is generated with reference to time to1. However, the present invention is not limited to this configuration. The coordinate reference signal may be generated with reference to time to2 at which second timing detection pulse V2 is generated, or the coordinate reference signal may be generated with reference to time to3 at which third timing detection pulse V3 is generated or time to4 at which fourth timing detection pulse V4 is generated.

Coordinate calculating circuit 56 includes a counter and an arithmetic circuit (not shown in FIG. 13) similarly to coordinate calculating circuit 42 shown in the first exemplary embodiment. Similarly to coordinate calculating circuit 42, coordinate calculating circuit 56 measures period Tyy from time ty0 to time tyy with the counter based on the coordinate reference signal and light receiving signal. Coordinate calculating circuit 56 calculates the y coordinate of the position of electronic pen 150 in the image display region by dividing period Tyy by period Ty1 with the arithmetic circuit. Similarly, coordinate calculating circuit 56 measures period Txx from time tx0 to time txx with the counter, and calculates the x coordinate of the position of electronic pen 150 in the image display region by dividing period Txx by period Tx1 with the arithmetic circuit. Here, time tyy is the time at which light receiving element 52 of electronic pen 150 receives the light emission by the y-coordinate detection pattern. Time txx is the time at which light receiving element 52 of electronic pen 150 receives light emission by the x-coordinate detection pattern.

Coordinate calculating circuit 56 of the present exemplary embodiment thus calculates the position (coordinates (x, y)) of electronic pen 150 in the image display region.

Transmitting circuit 58 includes a sending circuit (not shown in FIG. 13) for converting an electric signal into a wireless signal such as an infrared ray and sending the wireless signal. Transmitting circuit 58 converts the position (coordinates (x, y)) of electronic pen 150 calculated by coordinate calculating circuit 56 into a wireless signal, and wireless-transmits the wireless signal to receiving circuit 46.

Receiving circuit 46 includes a converting circuit (not shown in FIG. 13) for receiving the wireless signal wireless-transmitted from transmitting circuit 58 of electronic pen 150 and converting the wireless signal into an electric signal. Then, receiving circuit 46 converts the wireless signal wireless-transmitted from transmitting circuit 58 into a signal indicating the position (coordinates (x, y)) of electronic pen 150, and outputs the signal to drawing circuit 44.

The operations of drawing circuit 44 and later in the present exemplary embodiment are substantially the same as the operations of drawing circuit 44 and later in the first exemplary embodiment, so that the descriptions are omitted.

Thus, plasma display system 130 of the present exemplary embodiment includes the following elements:
electronic pen 150 for calculating the position coordinates of electronic pen 150 in the image display region and wireless-transmitting the calculated position coordinates to plasma display apparatus 110; and
plasma display apparatus 110 for receiving the position coordinates of electronic pen 150 wireless-transmitted from electronic pen 150 and drawing the path of electronic pen 150.

For example, in the configuration where a light receiving signal detected by the electronic pen is wireless-transmitted directly to the plasma display apparatus and the position coordinates are calculated with the coordinate calculating circuit included in the plasma display apparatus, there is the following possibility:
time tyy and time txx are not accurately transmitted to the coordinate calculating circuit due to time lag or the like occurring during transmitting/receiving of the wireless signal, and accurate position coordinates cannot be calculated.
   In the present exemplary embodiment, however, position coordinates are calculated by electronic pen 150 and the calculated position coordinates are transmitted to plasma display apparatus 110 by wireless communication. Therefore, plasma display system 130 of the present exemplary embodiment can draw the path of electronic pen 150 based on the accurate position coordinates.

The present exemplary embodiment has described the example where, in timing detection subfield SFo, four timing detection discharges are caused at the predetermined time intervals (for example, period To1, period To2, and period To3). However, the number of timing detection discharges is simply required to be two or more.

In the present exemplary embodiment, in timing detection subfield SFo, the time intervals (for example, period To1, period To2, and period To3) at which a plurality of (e.g. four) timing detection discharges are caused are set different from each other. However, these time intervals may be equal to each other. When these time intervals are set equal to each other, however, the following problem arises. For example, when the light receiving element of the electronic pen cannot receive the first timing detection discharge and can receive the other timing detection discharges, of the plurality of timing detection discharges, it is difficult to be determined whether the first timing detection discharge cannot be received or the final timing detection discharge cannot be received. Therefore, in order to prevent occurrence of such a problem, preferably, the time intervals at which a plurality of timing detection discharges are caused are set different from each other.

In the exemplary embodiments of the present invention, a plasma display apparatus using a plasma display panel in the image display unit is taken as an example of the image display device, and each operation is described. In the present invention, the image display device is not limited to the plasma display apparatus. When an image display system for displaying an image on the image display unit by the subfield method is employed, an effect similar to the above-mentioned effect can be produced by applying a configuration similar to the above-mentioned configuration.

In the exemplary embodiments of the present invention, as the y-coordinate detection pattern, a pattern is employed where one horizontal line to emit light (one pixel row to emit light) sequentially moves row by row from the upper end (first row) of the image display region of panel 10 to the lower end (n-th row). However, the y-coordinate detection pattern of the present invention is not limited to this pattern. For example, the y-coordinate detection pattern may be a pattern where a plurality of horizontal lines to emit light (a plurality of pixel rows to emit light) sequentially move every a plurality of rows from the upper end (first row) of the image display region of panel 10 to the lower end (n-th row). Alternatively, the y-coordinate detection pattern may be a pattern where one horizontal line to emit light (one pixel row to emit light) sequentially moves every other row from the upper end (first row) of the image display region of panel 10 to the lower end (n-th row). In these configurations, the period required for y-coordinate detection subfield SFy can be shortened comparing with the present exemplary embodiment.

In the exemplary embodiments of the present invention, as the x-coordinate detection pattern, a pattern is employed where one vertical line to emit light (one pixel column to emit light) sequentially moves column by column from the left end (first pixel column) of the image display region of panel 10 to the right end (m/3-th pixel column). However, the x-coordinate detection pattern of the present invention is not limited to this pattern. For example, the x-coordinate detection pattern may be a pattern where a plurality of vertical lines to emit light (a plurality of pixel columns to emit light) sequentially move every a plurality of columns from the left end (first pixel column) of the image display region of panel 10 to the right end (m/3-th pixel column). Alternatively, the x-coordinate detection pattern may be a pattern where one vertical line to emit light (one pixel column to emit light) sequentially moves every other column from the left end (first pixel column) of the image display region of panel 10 to the right end (m/3-th pixel column). In these configurations, the period required for x-coordinate detection subfield SFx can be shortened comparing with the present exemplary embodiment.

The exemplary embodiments of the present invention have described the configuration always having an image display subfield group and subfields for detecting the position coordinates in one field. The present invention is not limited to this configuration. For example, when a user does not use the electronic pen, one field may be constituted of only the image display subfield group.

The exemplary embodiments of the present invention have described the example having, in one field, a plurality of image display subfields constituting the image display subfield group and the subfields for detecting the position coordinates (y-coordinate detection subfield and x-coordinate detection subfield, and, in the second exemplary embodiment, timing detection subfield SFo). However, the present invention is not limited to this configuration. In addition to the above-mentioned subfields, a subfield having other function may be included in one filed, for example.

The exemplary embodiments of the present invention have described the configuration where the plasma display apparatus includes drawing circuit 44. However, the present invention is not limited to this configuration. For example, the configuration may be employed where a computer connected to the plasma display apparatus has a function corresponding to that of drawing circuit 44 and a drawing signal is generated using the computer.

The exemplary embodiments of the present invention have described the example where the electronic pen has a bar shape. However, the shape of the electronic pen of the present invention is not limited to the bar shape. The electronic pen may have any shape and any size as long as a user can perform a handwritten input of a character or drawing with one hand, and may have a shape other than the bar shape.

The present exemplary embodiment has described the example where the image display system includes a contact type electronic pen that allows a handwritten input only when the pen is in contact with the panel. The present invention is not limited to this configuration. Also in the image display system including a noncontact type electronic pen that allows a handwritten input even when the pen is not in contact with the panel, a configuration similar to the above-mentioned configuration can be employed, and an effect similar to the above-mentioned effect can be produced.

The number of subfields constituting one field, the subfield used as the forced initializing subfield, and the luminance weight of each subfield in the present invention are not limited to the above-mentioned numerical values. The subfield structure may be selected based on an image signal or the like.

The driving voltage waveforms of FIG. 3, FIG. 4, FIG. 10, and FIG. 12 are simply one example of the exemplary embodiments of the present invention, and the present invention is not limited to these driving voltage waveforms.

The circuit configurations of FIG. 5, FIG. 6, FIG. 7, FIG. 8, and FIG. 13 are also simply one example of the exemplary embodiments of the present invention, and the present invention is not limited to these circuit configurations.

Each circuit block shown in the exemplary embodiments of the present invention may be configured as an electric circuit for performing each operation shown in the exemplary embodiments, or may be configured using a microcomputer or computer programmed so as to perform substantially the same operation as that of the exemplary embodiments.

The exemplary embodiments of the present invention have described an example where one field has eight image display subfields constituting the image display subfield group. In the present invention, however, the number of image display subfields included in one field is not limited to the above-mentioned value. For example, when the number of image display subfields constituting the image display subfield group is increased, the number of gradations displayable on panel 10 can be further increased. When the number of image display subfields constituting the image display subfield group is decreased, the time required for driving panel 10 can be shortened.

The exemplary embodiments of the present invention have described the configuration always having the image display subfields and the subfields for detecting the position coordinates in one field. The present invention is not limited to this configuration. For example, when a user does not use the electronic pen, one field may be constituted of only the image display subfields.

The exemplary embodiments of the present invention have described the example where one pixel is formed of discharge cells of three colors, namely red, green, and blue. However, also in a panel where one pixel is formed of discharge cells of four or more colors, the configurations shown in the exemplary embodiments of the present invention can be employed and a similar effect can be produced.

Each specific numerical value shown in the exemplary embodiments of the present invention is set based on the characteristics of panel 10 having a screen size of 50 inches and having 1024 display electrode pairs 14, and is simply one example in the exemplary embodiments. The present invention is not limited to these numerical values. Preferably, numerical values are set optimally in response to the specification and characteristics of the panel and the specification of the plasma display apparatus. These numerical values can vary in a range allowing the above-mentioned effect. The number of subfields constituting one field and the luminance weight of each subfield are not limited to the values shown in the exemplary embodiments of the present invention, but the subfield structure may be changed based on an image signal or the like.

### INDUSTRIAL APPLICABILITY

In the present invention, discharge for detecting the position coordinates of an electronic pen is caused stably, and the position coordinates of the electronic pen can be detected accurately. The present invention is therefore useful as a driving method of an image display device, as the image display device, and as an image display system.

### REFERENCE MARKS IN THE DRAWINGS

10 panel
11 front substrate
12 scan electrode
13 sustain electrode
14 display electrode pair
15, 23 dielectric layer
16 protective layer
21 rear substrate
22 data electrode
24 barrier rib
25, 25R, 25G, 25B phosphor layer
30, 130 plasma display system
31 image signal processing circuit
32 data electrode driver circuit
33 scan electrode driver circuit
34 sustain electrode driver circuit
35 timing generation circuit
42 coordinate calculating circuit
44 drawing circuit
46 receiving circuit
50, 150 electronic pen
51, 81 power recovery circuit
52 light receiving element
54 timing detecting circuit
55, 80 sustain pulse generation circuit
56 coordinate calculating circuit
58 transmitting circuit
60 ramp voltage generation circuit
61, 62, 63 Miller integrating circuit
70 scan pulse generation circuit
85 fixed voltage generation circuit
100, 110 plasma display apparatus
Lx vertical line
Ly horizontal line
Di11, Di12, Di21, Di22, Di62 diode
L11, L12, L21, L22 inductor
Q11, Q12, Q21, Q22, Q55, Q56, Q59, Q69, Q72, Q83, Q84, Q86, Q87, Q71H1 through Q71Hn, Q71L1 through Q71Ln, Q91H1 through Q91Hm, Q91L1 through Q91Lm switching element
C10, C20, C61, C62, C63 capacitor
R61, R62, R63 resistor
Q61, Q62, Q63 transistor
IN61, IN62, IN63 input terminal
E71 power supply
SFx x-coordinate detection subfield
SFy y-coordinate detection subfield
SFo timing detection subfield

1. A driving method of an image display device including an image display unit formed of a plurality of scan electrodes and sustain electrodes and a plurality of data electrodes, the driving method comprising:
having an image display subfield, a y-coordinate detection subfield, and an x-coordinate detection subfield in one field;
in the y-coordinate detection subfield, applying a y-coordinate detection voltage to the data electrodes and sequentially applying y-coordinate detection pulses to the scan electrodes;
in the x-coordinate detection subfield, applying an x-coordinate detection voltage to the scan electrodes and sequentially applying x-coordinate detection pulses to the data electrodes;
setting an initializing period, in which a down-ramp voltage is applied to the scan electrodes, in the x-coordinate detection subfield and the image display subfield;
in the initializing period of the x-coordinate detection subfield, applying a first voltage to the data electrodes and applying a first down-ramp voltage to the scan electrodes;
in the initializing period of the image display subfield, applying a second voltage to the data electrodes and applying a second down-ramp voltage to the scan electrodes; and
setting a voltage derived by subtracting an arrival voltage of the first down-ramp voltage from the first voltage to be higher than a voltage derived by subtracting an arrival voltage of the second down-ramp voltage from the second voltage.

2. The driving method of the image display device of claim 1 further comprising:
setting the arrival voltage of the first down-ramp voltage to be higher than the arrival voltage of the second down-ramp voltage.

3. The driving method of the image display device of claim 1 further comprising:
setting the first voltage to be higher than the second voltage.

4. The driving method of the image display device of claim 1 further comprising:
applying a third voltage to the sustain electrodes in the initializing period of the x-coordinate detection subfield;
applying a fourth voltage to the sustain electrodes in the initializing period of the image display subfield; and
setting the third voltage to be higher than the fourth voltage.

5. An image display device comprising:
an image display unit formed of a plurality of scan electrodes and sustain electrodes and a plurality of data electrodes; and
a driver circuit for driving the image display unit by forming one field using a plurality of subfields,
wherein
the driver circuit displays an image on the image display unit by having an image display subfield, a y-coordinate detection subfield, and an x-coordinate detection subfield in one field,
in the y-coordinate detection subfield, the driver circuit applies a y-coordinate detection voltage to the data electrodes and sequentially applies y-coordinate detection pulses to the scan electrodes,
in the x-coordinate detection subfield, the driver circuit applies an x-coordinate detection voltage to the scan electrodes and sequentially applies x-coordinate detection pulses to the data electrodes,
the driver circuit sets an initializing period, in which a down-ramp voltage is applied to the scan electrodes, in the x-coordinate detection subfield and the image display subfield,
in the initializing period of the x-coordinate detection subfield, the driver circuit applies a first voltage to the data electrodes and applies a first down-ramp voltage to the scan electrodes,
in the initializing period of the image display subfield, the driver circuit applies a second voltage to the data electrodes and applies a second down-ramp voltage to the scan electrodes, and
the driver circuit sets a voltage derived by subtracting an arrival voltage of the first down-ramp voltage from the first voltage to be higher than a voltage derived by subtracting an arrival voltage of the second down-ramp voltage from the second voltage.

6. An image display system comprising:
an image display device including an image display unit, the image display unit formed of a plurality of scan electrodes and sustain electrodes and a plurality of data electrodes;
an electronic pen;
a coordinate calculating circuit; and
a drawing circuit,
wherein
the image display device displays an image on the image display unit by having an image display subfield, a y-coordinate detection subfield, and an x-coordinate detection subfield in one field,
in the y-coordinate detection subfield, the image display device applies a y-coordinate detection voltage to the data electrodes and sequentially applies y-coordinate detection pulses to the scan electrodes, and
in the x-coordinate detection subfield, the image display device applies an x-coordinate detection voltage to the scan electrodes and sequentially applies x-coordinate detection pulses to the data electrodes,
wherein the electronic pen receives a light emission occurring in the image display unit in the y-coordinate detection subfield and a light emission occurring in the image display unit in the x-coordinate detection subfield, and outputs a light receiving signal,
wherein, based on the light receiving signal, the coordinate calculating circuit calculates:
a coordinate indicating a position of a light emission, received by the electronic pen, of the light emission occurring in the image display unit in the y-coordinate detection subfield; and
a coordinate indicating a position of a light emission, received by the electronic pen, of the light emission occurring in the image display unit in the x-coordinate detection subfield,
wherein the drawing circuit generates a drawing signal for displaying, on the image display unit, an image based on the coordinates calculated by the coordinate calculating circuit, and
wherein
the image display device sets an initializing period, in which a down-ramp voltage is applied to the scan electrodes, in the x-coordinate detection subfield and the image display subfield, and displays an image based on the drawing signal on the image display unit,
in the initializing period of the x-coordinate detection subfield, the image display device applies a first voltage to the data electrodes and applies a first down-ramp voltage to the scan electrodes,
in the initializing period of the image display subfield, the image display device applies a second voltage to the data electrodes and applies a second down-ramp voltage to the scan electrodes, and
the image display device sets a voltage derived by subtracting an arrival voltage of the first down-ramp voltage from the first voltage to be higher than a voltage derived by subtracting an arrival voltage of the second down-ramp voltage from the second voltage.
